(19) United States
(12) Patent Application Publication
(10) Pub. No.: US 2005/0147487 A1
(43) Pub. Date: Jul. 7, 2005

(54) Post-processing apparatus and image-forming system

(75) Inventors: Hiroyuki Wakabayashi, Tokyo (JP); Toshio Shida, Tokyo (JP); Masaaki Uchiyama, Tokyo (JP); Masato Hattori, Tokyo (JP); Kenji Kawatsu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/058,619

(22) Filed: Feb. 16, 2005

Related U.S. Application Data
(63) Continuation-in-part of application No. 10/893,952, filed on Jul. 20, 2004.

(30) Foreign Application Priority Data
Oct. 1, 2003 (JP) JP2003-342927
Apr. 22, 2004 (JP) JP2004-126447

(51) Int. Cl. B42C 1/00

(52) U.S. Cl. 412/9

(57) ABSTRACT

A post-processing apparatus post-processing a booklet having a bundle of center-folded sheets. The apparatus comprises a trimming apparatus trimming an edge portion of the booklet, a skew-correcting device correcting a skew of the booklet, a pressing device flattening the booklet by pressing, and a transferring device conveying the booklet into a trimming process opening section of the trimming apparatus by transferring the pressing device. And the booklet the skew of which is corrected by the skew-correcting device is pressed by the pressing device and the booklet is conveyed into the trimming process opening section by the transferring device while the booklet is pressed by the pressing device.

This application is a continuation-in-part application of U.S. patent application Ser. No. 10/893,952, filed on Jul. 20, 2004.

### BACKGROUND OF THE INVENTION

The present invention relates to a post-processing apparatus for trimming the edge of the center-folded and saddle-stitched sheets on which images outputted from an image-forming apparatus have been recorded, and also relates to an image-forming system comprising the aforementioned post-processing apparatus.

Conventionally, the printing industry has achieved the practical use of a post-processing apparatus comprising a trimming apparatus for trimming the edge of a booklet which has been saddle-stitched and center-folded.

Also recently, there has been presented a post-processing apparatus, incorporating a trimming apparatus, which saddle-stitches and center-folds the sheets having images created by an image-forming apparatus, such as a copier, printer, etc., in order to bind them as a booklet like a weekly magazine, and then trims the edge of the booklet by means of the built-in trimming apparatus to neatly align the edge.

A trimming apparatus disclosed in patent document 1 comprises a lower transporting belt for transporting a saddle-stitched and center-folded booklet, a pressing means for pressing the upper surface of the booklet loaded on the lower transporting belt, a elevating means for elevating the pressing means, and a drive means for driving the elevating means, wherein the elevating means and the drive means are located below the lower transporting belt.

A trimming apparatus disclosed in patent document 2 has a booklet storing means which stores a plurality of booklets that have been trimmed, wherein the booklets are held with the folds face up and their sheets pressed against one another.

[Patent document 1] Official Gazette of Japanese Patent Tokkai 2001-240296

[Patent document 2] Official Gazette of Japanese Patent Tokkai 2001-240288

As shown in patent documents 1 and 2, in the conventional trimming apparatus, a saddle-stitched and center-folded booklet is transported by a rotating transporting belt, inserted into a trimmer portion of the trimming means with the booklet's fold leading, stops at a prescribed location when the leading edge of the booklet contacts a stopper protruding into a booklet transporting passage, and then the booklet's trailing edge in the transporting direction is trimmed by a trimming means while the booklet is pressed by a pressing means that can be elevated.

The booklet the edge of which has been trimmed is transported with the booklet's fold leading to be stacked in a booklet storing section.

With regard to a conventional trimming apparatus like this, it does not have any means to correct sufficiently a skew of a booklet fed to a trimming portion before a trimming process. Therefore, there is a possibility that the trimming is carried out while the leading edge of the booklet is contacting a stopper unevenly and the edge portion of the booklet is not accurately parallel to the fold portion after the trimming process.

A booklet to be trimmed is fed in one direction through a trimming portion of a trimming apparatus to a booklet-storing portion. Therefore, if interference between composing members of the trimming portion and a swollen portion of booklet near the trimming portion occurs or a defective operation of disposal of trimmed scraps occurs, there happen problems such as a transportation defection.

An object of the invention is, in a trimming apparatus to trim an edge portion of a booklet, to achieve an improvement of stability of a skew correction of a booklet to be fed to a trimming apparatus and transportation of a booklet to be inserted in a trimming process opening section of a trimming apparatus. Further, the invention aims at achieving simplification of a booklet-transporting mechanism and an improvement of the quality of a booklet the edge of which is trimmed.

### SUMMARY OF THE INVENTION

The above objectives can be achieved by the following configuration:

(1). A post-processing apparatus post-processing a booklet having a bundle of center-folded sheets and comprising: a trimming apparatus trimming an edge portion of the booklet; a skew-correcting device correcting a skew of the booklet; a pressing device flattening the booklet by pressing; and a transferring device conveying the booklet into a trimming process opening section of the trimming apparatus by transferring the pressing device; wherein the booklet the skew of which is corrected by the skew-correcting device is pressed by the pressing device and the booklet is conveyed into the trimming process opening section by the transferring device while the booklet is pressed by the pressing device.

(2). An image-forming system including post-processing apparatus which post-processes a booklet having a bundle of center-folded sheets comprising: an image-forming apparatus recording images on sheets constituting the booklet; a trimming apparatus trimming the edge portion of the booklet; a skew-correcting device correcting a skew of the booklet; a pressing device flattening the booklet by pressing; and a transferring device conveying the booklet into a trimming process opening section of the trimming apparatus by transferring the pressing device; wherein the booklet the skew of which is corrected by the skew-correcting device is pressed by the pressing device and the booklet is conveyed into the trimming process opening section by the transferring device while the booklet is pressed by the pressing device.

### BRIEF DESCRIPTION OF THE DRAWING

FIG. 1 is a schematic diagram of an image-forming system including an image-forming apparatus, automatic document feeder, post-processing apparatus, and a large-capacity paper feeder.

FIG. 2 is a frame format of the sheet transporting process in a post-processing apparatus.

FIG. 3 is a frame format showing how sheets are transported during the center-folding and saddle-stitching processes in a post-processing apparatus.

FIG. 4 is a front view of a post-processing apparatus.

FIG. 5 is a right side view of a post-processing apparatus.

FIG. 6 is a left side view of a post-processing apparatus.

FIG. 7 is a schematic diagram of a drive mechanism for transporting booklets.

FIG. 8 is a cross-sectional view of a swinging mechanism for swinging a booklet transporting device including a transporting belt.

FIG. 9 is a cross-sectional view which shows a drive mechanism for elevating a pressing member and a transfer device for moving a mobile body that supports the pressing member in the direction of transporting booklets.

FIG. 10 is a perspective view of a drive mechanism for elevating a pressing member.

FIG. 11 shows cross-sectional views of a drive mechanism for a reference alignment member.

FIG. 12 shows a front view and a side cross-sectional view of a trimming apparatus.

FIG. 13 is a cross-sectional view of a drive mechanism for an edge pressing member.

FIG. 14 is a cross-sectional view of a drive mechanism for discharging trimmed scraps.

FIG. 15 is a cross-sectional view showing the process in which a center-folded and saddle-stitched booklet is transported and inserted into a trimming apparatus.

FIG. 16 is a cross-sectional view showing the process in which a booklet is sent to a trimming apparatus.

FIG. 17 is a cross-sectional view showing the process in which a booklet is sent to a trimming apparatus.

FIG. 18 is a cross-sectional view showing the process in which a booklet is sent to a trimming apparatus.

FIG. 19 is a cross-sectional view showing the process in which a booklet is sent to a trimming apparatus.

FIG. 20 is a cross-sectional view showing the process in which the edge portion of a booklet is trimmed by a trimming apparatus.

FIG. 21 is a cross-sectional view showing the process in which the edge portion of a booklet is trimmed by a trimming apparatus.

FIG. 22 is a cross-sectional view showing the process in which the trimmed booklet is discharged.

FIG. 23 is a cross-sectional view showing the process in which the trimmed booklet is discharged.

FIG. 24 is an explanatory drawing showing a variety of inclination angles of the booklet transporting means.

FIG. 25 shows a cross-sectional view showing the state in which the discharge belt is stored in the post-processing apparatus, and a cross-sectional view showing the state in which the discharge belt is pulled out in the direction of the front side of the post-processing apparatus.

FIG. 26 is a cross-sectional view showing the state in which booklets are stacked on the discharge belt.

FIG. 27 is a schematic diagram of a drive mechanism for transporting booklets.

FIG. 28 is a cross-sectional view of a swinging mechanism for swinging a booklet transporting device including a transporting belt.

FIG. 29 is a cross-sectional view which shows a drive mechanism for elevating a pressing member and a booklet pinching transfer device.

FIG. 30 is a perspective view of a drive means for elevating a pressing member.

FIG. 31 is a cross-sectional view showing an elevating drive of edge pressing member.

FIG. 32 is a cross-sectional view of the neighborhood of a trimming apparatus.

FIG. 33 is a side view of the neighborhood of a trimming apparatus.

FIG. 34 shows a front view and a side cross-sectional view of a trimming apparatus.

FIG. 35 includes cross-sectional views showing examples of a trimming apparatus.

FIG. 36 is a block diagram showing control of a sheet post-processing apparatus.

FIG. 37 is a cross-sectional view showing the first embodiment of a process in which a booklet is transported and fed to a trimming apparatus after a skew correction.

FIG. 38 is a cross-sectional view showing the first embodiment of a process in which a booklet is sent to a trimming apparatus.

FIG. 39 is a cross-sectional view showing the first embodiment of a process in which a booklet is sent to a trimming apparatus.

FIG. 40 is a cross sectional view showing the first embodiment for a skew correction of booklet.

FIG. 41 is a cross-sectional view showing the first embodiment of a transportation of a booklet to a trimming process opening section.

FIG. 42 is a cross-sectional view showing the second embodiment of a process in which a booklet is transported after a skew correction.

FIG. 43 is a cross-sectional view showing a process in which a trimmed booklet is discharged.

FIG. 44 is a cross-sectional view showing a process in which a trimmed booklet is discharged.

### DETAILED DESCRIPTION OF THE PREFERRED EMBODIMENT

Hereafter, a post-processing apparatus according to the present invention and an image-forming system incorporating the post-processing apparatus will be described in detail with reference to the drawings. However, a post-processing apparatus according to the present invention and an image-forming system incorporating the post-processing apparatus are not limited to the embodiment described below.

[Image-Forming System]

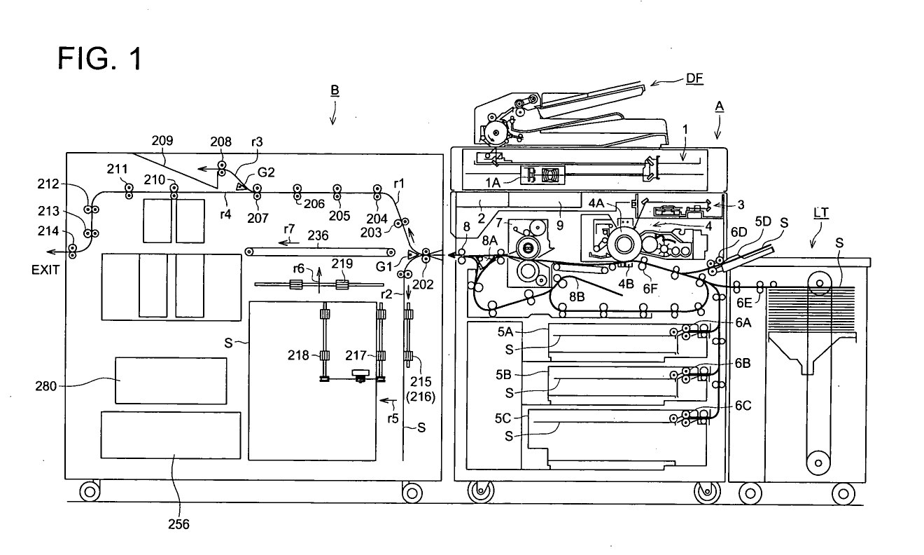

FIG. 1 is a schematic diagram of an image-forming system comprising an image-forming apparatus A, automatic document feeder DF, post-processing apparatus B, and a large-capacity paper feeder LT.

As shown in the drawing, the image-forming apparatus A comprises an image-reading portion 1, image-processing portion 2, image-writing portion 3, image-forming portion 4, paper feed cassettes 5A, 5B and 5C, manual paper-feed tray 5D, 1st paper feeders 6A, 6B, 6C and 6D, 2nd paper feeder 6F, fixation device 7, paper discharge portion 8, and an automatic both-side copy paper feeder (ADU) 8B.

An automatic document feeder DF is located at the upper part of the image-forming apparatus A. A post-processing apparatus B is connected to the paper discharge portion 8 which is located on the left side of the image-forming apparatus A as shown in the drawing.

The optical system of the image-reading portion 1 scans an image created on one side or images created on both sides of a document placed on the document placement board of the automatic document feeder DF, and then a CCD image sensor 1A reads the image or images.

Analog signals which have been photoelectrically transduced by the CCD image sensor 1A are analog-processed, A/D converted, processed with shading correction and image compression in the image-processing portion 2 and then sent to the image-writing portion 3.

In the image-writing portion 3, a semiconductor laser irradiates a ray of light onto a photoreceptor drum 4A in the image-forming portion 4 thereby creating a latent image. Processing, such as electrification, exposure, development, transfer, separation, and cleaning, is conducted in the image-forming portion 4. On a sheet S which has been fed from a paper feed cassette 5A through 5C, manual paper feed tray 5D, or a large-capacity paper feeder LT via a 1st paper feeder 6A through 6E, an image is transferred by a transfer device 4B. The sheet S which carries the image is fixed by a fixation device 7 and sent from the paper discharge portion 8 to the post-processing apparatus B. Or, a sheet S one side of which had an image processed is sent to the automatic both-side copy paper feeder 8B by means of the transporting passage switching board 8A, and then another image is processed on the other side of the sheet S in the image-forming portion 4 and the sheet is then discharged from the paper discharge portion 8.

The operating portion 9 selects a processing function of the image-forming system including an image-forming apparatus A and a post-processing apparatus B.

[Post-Processing Apparatus]

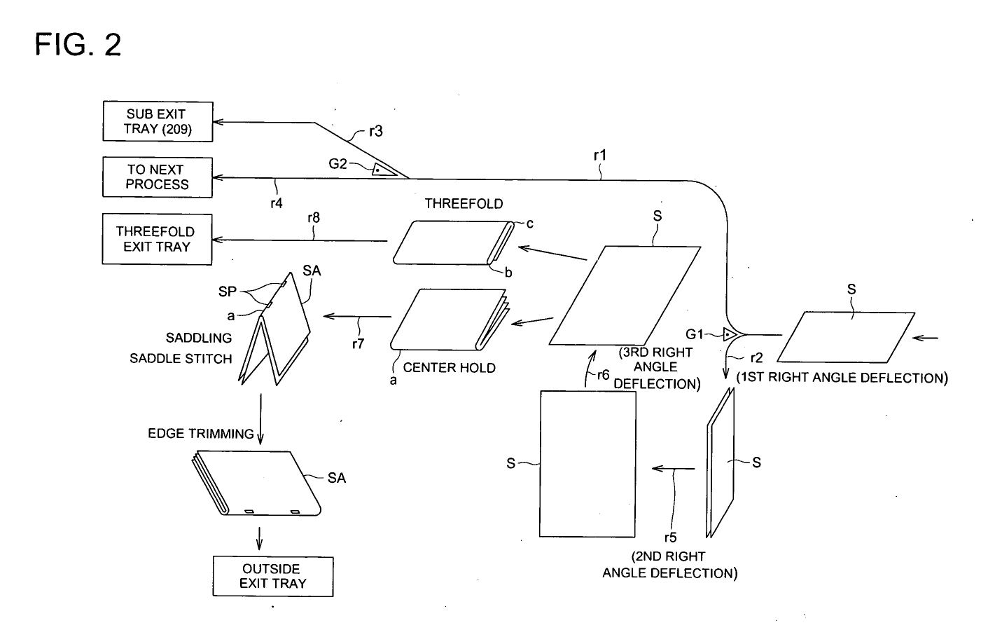

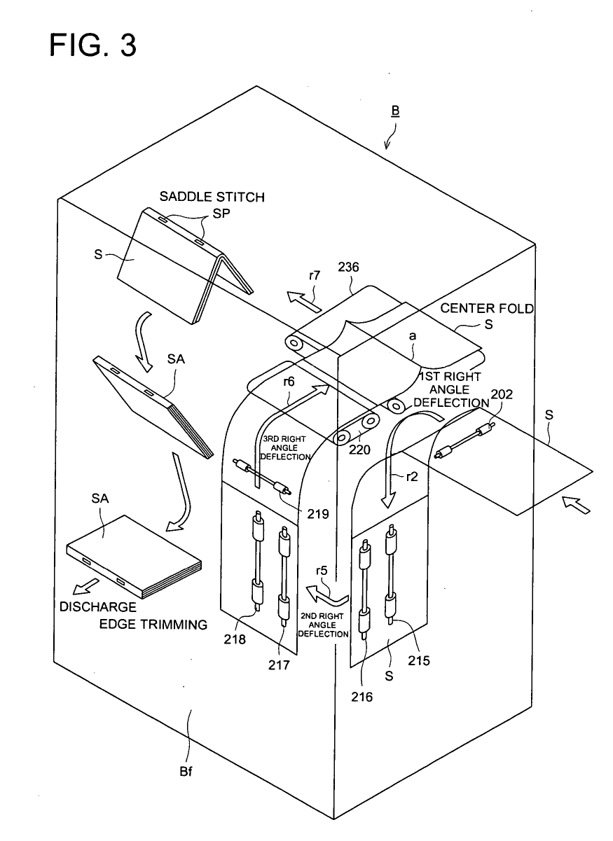

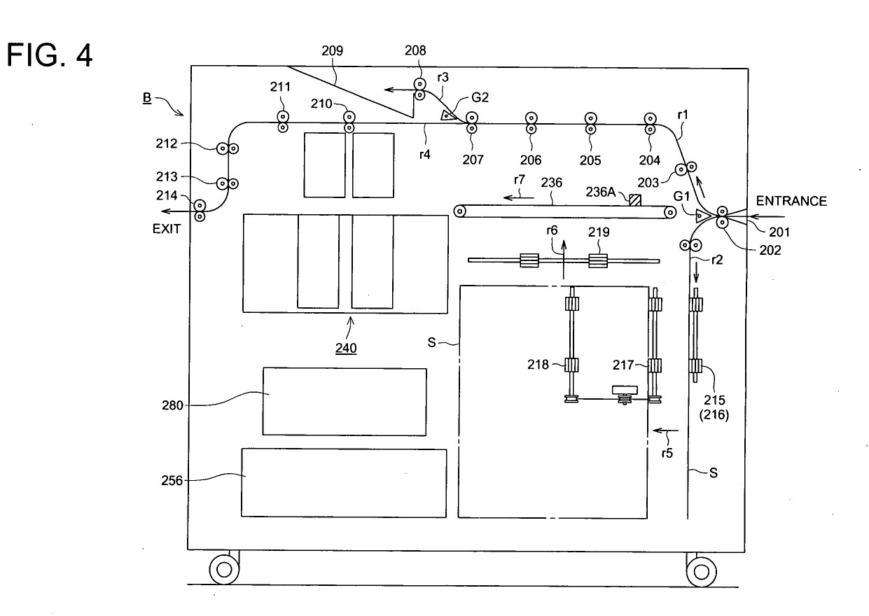

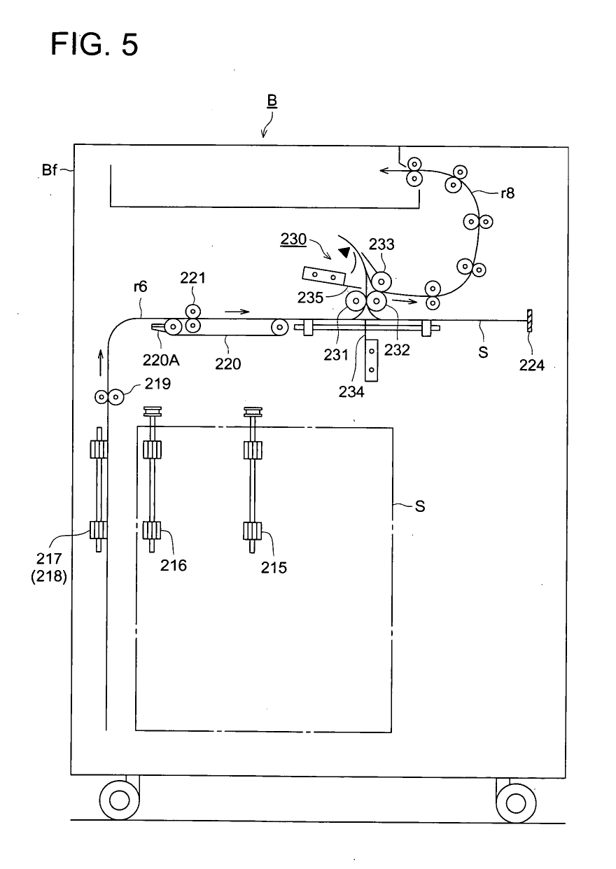

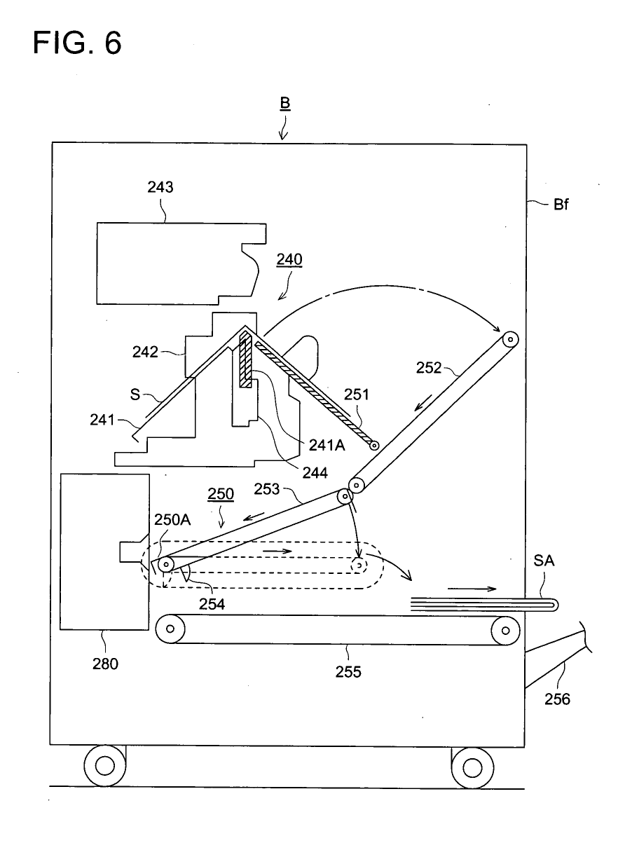

FIG. 2 is a frame format of the sheet transporting process in a post-processing apparatus. FIG. 3 is a frame format showing how sheets are transported during the center-folding and saddle-stitching processes in a post-processing apparatus. FIG. 4 is a front view, FIG. 5 is a right side view and FIG. 6 is a left side view of a post-processing apparatus.

First, the sheet transporting process, starting from a sheet being fed and up to the folding process, will be described.

As shown in FIGS. 1 and 4, a sheet S discharged from the image-forming apparatus A is loaded into an entrance (loading portion) 201 of the post-processing apparatus B, supported by entrance rollers 202, and then transported to either a transporting passage r1 above the transporting passage switching member G1 or transporting passage r2 below the transporting passage switching member G1.

Straight Paper Discharge

A sheet S transported to the transporting passage r1 is supported by transporting rollers 203 through 207, and then transported to either a transporting passage r3 above the transporting passage switching member G2 or transporting passage r4 below the transporting passage switching member G2.

The sheet S transported to the upper transporting passage r3 is discharged by paper discharge rollers 208 and then stacked on the sub exit tray (top tray) 209 located at the upper part of the post-processing apparatus B.

The sheet S transported to the lower transporting passage r4 is supported by transporting rollers 210 through 213 and then discharged by paper discharge rollers 214.

1st Right Angle Deflection Transporting

A sheet S transported to the transporting passage r2 below the transporting passage switching member G1 is lowered vertically, stops temporarily at a prescribed position and then stored. At the stop position, a plurality of sheets S discharged successively thereafter are stacked and stored.

2nd Right Angle Deflection Transporting

The stored sheets S is deflected in a direction perpendicular to its surface as shown in FIG. 2 by the transporting rollers 215 through 218 and a guide plate, not shown, passes through the transporting passage r5 which detours the sheets to the front side Bf in the post-processing apparatus B while the sheet surface stands upright, and temporarily stops at a prescribed position.

3rd Right Angle Deflection Transporting

Next, the sheets S is transported vertically in an upward direction by transporting rollers 219, deflected to a horizontal position, and then transported to an alignment device by the transporting alignment belt 220 and the transporting roller 221 (transporting passage r6).

Alignment Prior to the Folding Process

An alignment device comprising an alignment member 224, which is located downstream of the transporting passage r6 in the direction of transporting sheets and contacts the leading edge of the sheets to align the sheets, and a movable alignment block (alignment claw) 220A which presses the trailing edge of the sheets S and transports them. The alignment block 220A presses the trailing edge of the sheets S transported by a transporting roller 221 located upstream of the transporting passage r6 in the direction of transporting the sheets and transports the sheets to the alignment member 224, and then touches the leading edge of the sheets to the alignment member 224 thereby aligning the sheets.

The following is a detailed explanation of the edge trimming process of the center-folded and saddle-stitched booklet made of sheets S in the post-processing apparatus B.

Center-Folding Function

A folding portion 230 is located downstream of the transporting alignment belt 220 in the direction of transporting sheets. The folding portion 230 comprises a 1st folding roller 231, 2nd folding roller 232, 3rd folding roller 233, 1st folding plate member 234, and a 2nd folding plate member 235.

One or more sheets S which have been carried to the folding portion 230 are supported by the 1st folding roller 231 and the 2nd folding roller 232 which rotate in the opposite directions to one another and the 1st folding plate member 234 which moves straight, and a fold “a” is created in the same direction as the width of the sheets in the middle of the sheet transporting direction (see FIG. 5).

After that, both the 1st folding roller 231 and the 2nd folding roller 232 are rotated in the reverse directions. The sheets S on which a fold “a” has been created is removed from the position at which it was nipped by the 1st folding roller 231 and the 2nd folding roller 232 and returned to the original horizontal transporting passage. The sheets S is then transported by a transporting claw 236A (see FIG. 4) mounted to the rotating transporting belt 236 to the transporting passage r7 located in the direction of the extension line of the fold “a” (see FIGS. 2 and 3), and then sent to the saddle-stitching portion 240.

Thus, the folding portion 230 center-folds one to three sheets S to precisely create a fold “a”, and sends the sheets to the saddle-stitching portion 240 at each time. As a result, it is possible to make a high-quality booklet (book-bound item) SA which has minimum swollen along the fold “a”.

Saddle-Stitching Function

The sheets S center-folded in the folding portion 230 is transported to the transporting passage r7 by the transporting belt 236 and a guide means, not shown, and is placed on the saddling integration member 241 located in the saddle-stitching portion 240. The subsequent center-folded sheet S is then also transported via the transporting passage r7 and placed on the saddling integration member 241 (see FIG. 6).

The saddling integration member 241 comprising two guide plates which are almost perpendicular to one another, and is mounted to the main body of the apparatus. In the vicinity of the top of the saddling integration member 241, a pressing member 241A which can be elevated by means of the spring force is placed into position and supported by a staple receiving mechanism 244.

The top of the pressing member 241A is convex which is almost perpendicular in an upward direction and the fold “a” (see FIG. 2) of the center-folded sheet S is placed on the top ridgeline.

A plurality of sheets S placed on the saddling integration member 241 and the pressing member 241A are aligned by a width alignment member 242.

A stapling mechanism 243 is firmly provided above the pressing member 241A. Inside the saddling integration member 241, the pressing member 241A and the staple receiving mechanism 244 are supported in such a way that allows them to move vertically.

Two sets of block-structured binding device which comprises a stapling mechanism 243 and a staple receiving mechanism 244 are disposed in the same direction as that of the sheets' fold. When the saddle-stitching is selected by the operating portion, the staple receiving mechanism 244 lifts and conducts the saddle-stitching process. That is, two sets of binding devices staple the booklet SA placed on the pressing member 241A by using staples SP at two center distribution locations along the fold “a”. The center-folded and saddle-stitched booklet SA is shown in a perspective view in FIG. 3.

Booklet Trimming Function

The booklet SA which has been saddle-stitched in the saddle-stitching portion 240 is supported by a guide member 251 that can swing and is swung in the direction, indicated by the dot-dash line, and is placed on the transporting belt 252. The booklet SA is transported obliquely downward by the circular movement of the transporting belt 252, held at an angle, transferred by the rotating transporting belt 253 and then stops at a prescribed position.

After that, the transporting belt 253 swings to become horizontal. The edge (free end on the opposite side of the fold) of the booklet SA which is placed on the horizontally located transporting belt 253 is uneven because multiple sheets of the booklet SA have been bound, and therefore, the edge is trimmed by the trimming apparatus (trimmer) 280 to neatly align the edge.

The trimmed booklet SA is loaded on the reverse-rotating transporting belt 253 and is transported while the trailing edge of the booklet SA is being pressed by a contact member (movable alignment member) 254 mounted to the transporting belt 253, and then the booklet is discharged from the leading edge of the transporting belt 253 in the direction indicated by the arrow. The ejected booklet SA is discharged by the rotating discharge belt 255 in the exit tray 256 located outside the front side Bf of the post-processing apparatus B.

### The First Embodiment of Edge-Trimming Apparatus

Next, the mechanism of the trimming apparatus 280 and the drive mechanism for transporting booklets will be described in detail.

Drive Mechanism for Transporting Booklets

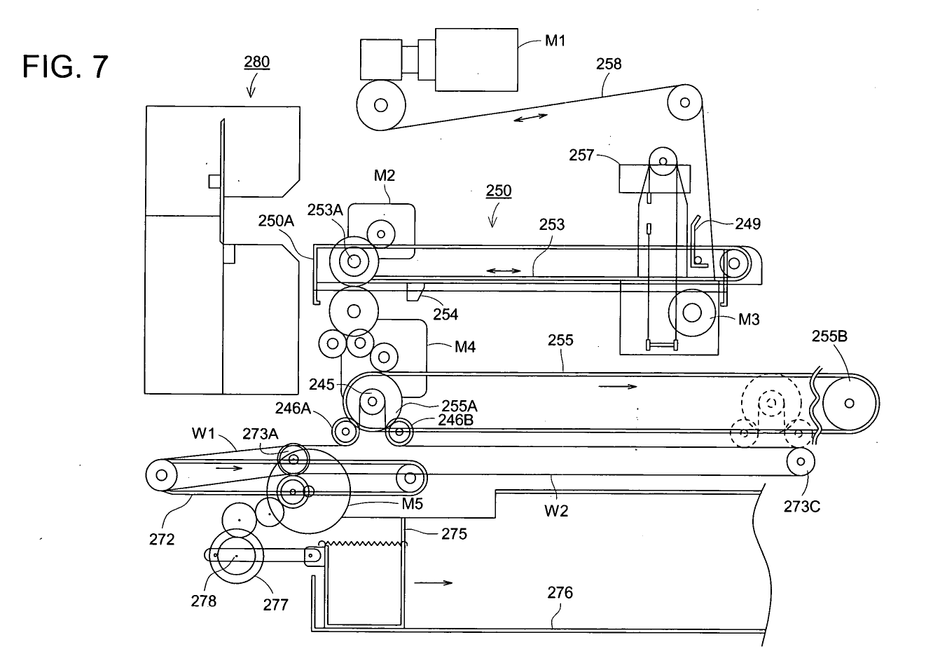

FIG. 7 is a schematic diagram of a drive mechanism for transporting booklets.

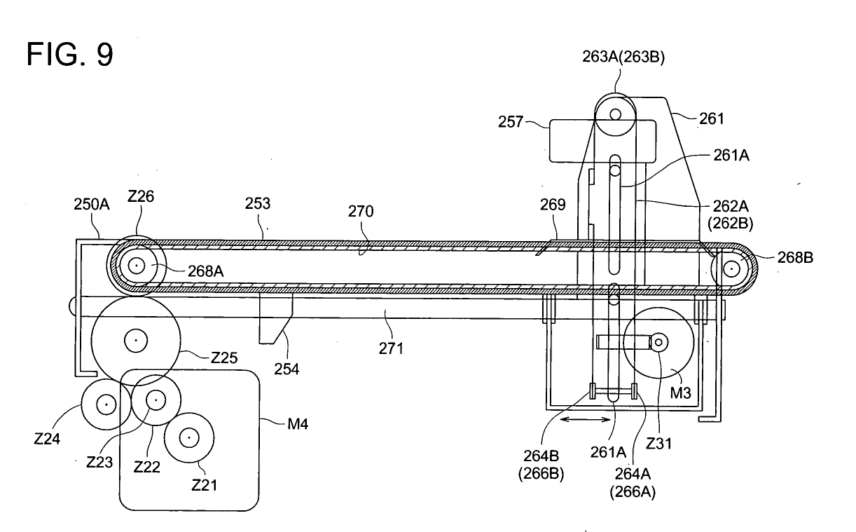

The motor M1 swings the transporting belt 253 around the drive roller rotating shaft 253A and elevates the belt. The motor M2 rotates in two directions, forward and reverse, the transporting belt 253 which incorporates the contact member 254. The motor M3 elevates the pressing member 257 which presses the vicinity of the fold of the booklet SA. The motor M4 moves a mobile body 261 straight in the direction of transporting the booklet. (This will be explained in detail in FIG. 9.) The motor M5 rotates the discharge belt 255 which winds around both the drive roller 255A and the driven roller 255B, rotates the trimmed-scrap transporting belt 272, and moves the transfer member 275 of the trimmed-scrap container 276.

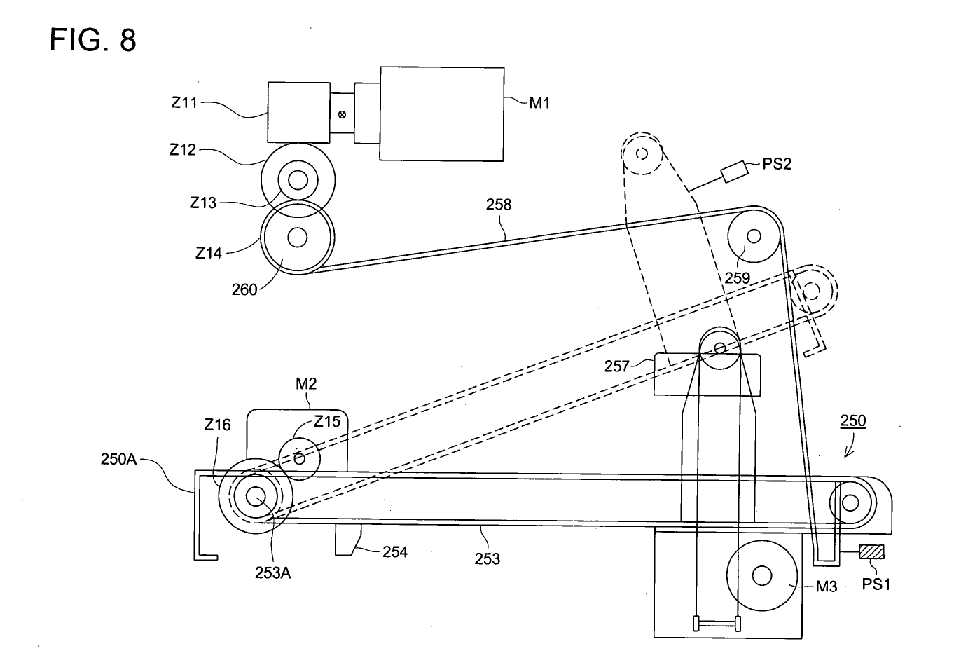

FIG. 8 is a cross-sectional view of a swinging mechanism for swinging a booklet transporting device including a transporting belt 250.

The transporting belt 253 of the booklet transporting device 250 is supported such that it can swings around the drive roller rotating shaft 253A. A wire 258 one end of which is latched to the end (the right side as shown in the drawing) of the booklet transporting device 250 is deflected along the outer circumferential surface of the intermediate roller 259 which is rotatably supported by the apparatus' main body, and winds around the outer circumferential surface of the pulley 260, and then the other end of the wire is mounted to the pulley 260 in the tensioned state.

A gear Z14 mounted to the rotating shaft of the pulley 260 is connected to the gear Z11 which is mounted to the motor M1's drive shaft via the intermediate gears Z13 and Z12.

The motor M1 rotates the pulley 260 to wind up the wire 258, lifts a booklet transporting means 250 comprising a booklet placement board 250A and a transporting belt 253, and swings the booklet transporting device 250 upward around the drive roller rotating shaft 253A and lifts it. The lifting position of the booklet transporting device 250 is indicated in the broken line. PS1 denotes a sensor for detecting the lower-limit position of the booklet transporting means 250 and PS2 denotes a sensor for detecting the upper-limit position of the booklet transporting means 250.

To lower the booklet transporting means 250 to a horizontal position, the motor M1 drives in the reverse direction to change the rotation direction of the pulley 260, releases the tension force of the wire 258, and then the booklet transporting device 250 is allowed to be lowered by its own weight.

The motor M2 rotates the drive roller rotating shaft 253A via gears Z15 and Z16 to rotate the transporting belt 253 in the forward and reverse direction.

Drive Mechanism for Elevating the Pressing Member

FIG. 9 is a cross-sectional view which shows a drive mechanism for elevating a pressing member 257 and a transfer device for moving a mobile body 261 that supports the pressing member 257 in the direction of transporting booklets.

The transfer device for moving a mobile body in the direction of transporting booklets comprises a booklet supporting plate 269 mounted to the mobile body 261, a pressing member 257 which can be elevated, a mobile-body drive mechanism, and a drive mechanism for elevating the pressing member.

The motor M3 elevates the pressing member 257 which presses the vicinity of the fold of the booklet SA. The pressing member 257 is supported along the long groove 261A of the mobile body 261 such that it can be elevated.

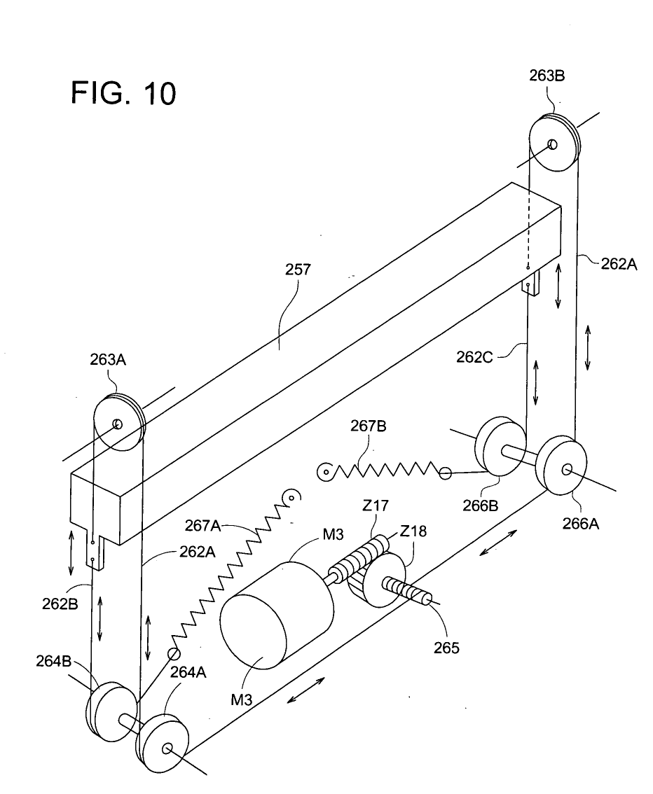

FIG. 10 is a perspective view of a drive means for elevating a pressing member 257.

The 1st wire 262A one end of which is latched to the pressing member 257 winds around the sheave 263A, winds around the pulley 264A, also winds around the outer circumferential surface of the pulley 265 a plurality of times, and then winds around the pulley 266A, winds around the sheave 263B, and then the other end of the wire 262A is mounted to the pressing member 257 in the tensioned state.

The 2nd wire 262B one end of which is latched to the pressing member 257 winds around the pulley 264B and then connected to one end of the spring 267A. The other end of the spring 267A is latched to the apparatus' main body.

The 3rd wire 262C one end of which is latched to the pressing member 257 winds around the pulley 266B and then connected to one end of the spring 267B. The other end of the spring 267B is latched to the apparatus' main body.

The forward rotational drive of the motor M3 rotates the pulley 265 in the forward direction via gears Z17 and Z18, and the wire 262A is wound up and then the pressing member 257 is elevated via the sheaves 263A and 263B.

The reverse rotational drive of the motor M3 reverses the rotation of the pulley 265, and the wire 262A changes the position in the reverse direction, making it possible to lower the pressing member 257 via sheaves 263A and 263B. The wire 262B latched to the pressing member 257 lowers the pressing member 257 by means of the force of the spring 267A. Simultaneously, the wire 262C latched to the pressing member 257 lowers the pressing member 257 by means of the force of the spring 267B. As the pressing member 257 lowers, the vicinity of the fold of the booklet SA loaded on the booklet placement board 250A is pressed.

Drive Mechanism for Moving the Pressing Member in the Direction of Transporting a Booklet

In FIG. 9, the motor M4 moves the pressing member 257 straight in the direction of transporting a booklet. The rotational drive of the motor M4 rotates a drive pulley 268A via gears Z21, Z22, Z23, Z24, Z25 and Z26. A mobile body 261 is latched to the belt 270 which winds around the drive pulley 268A and the driven pulley 268B. The mobile body 261 is supported by the guide bar 271 which is installed on the booklet placement board 250A in parallel with the direction of transporting a booklet so that the mobile body 261 can slide. The rotational drive of the motor M4 rotates the belt 270 and moves the mobile body 261 back and forth along the guide bar 271.

Driving the Reference Alignment Member

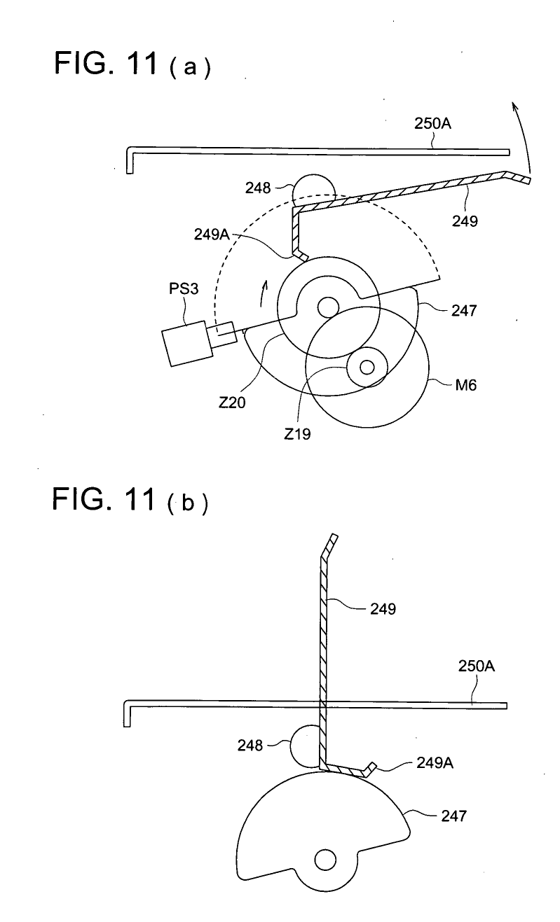

FIGS. 11(a) and (b) are cross-sectional views of a drive mechanism for a reference alignment member 249. FIG. 11(a) shows the reference alignment member 249 positioned below the booklet placement board 250A, and FIG. 11(b) shows the reference alignment member 249 in the upright position and protruding upwardly over the booklet placement board 250A.

The reference alignment member 249 is mounted to the swinging shaft 248 installed on one end of the booklet placement board 250A so that the member can swing (see FIG. 7). In the initial state, the reference alignment member 249 stands by in such a way that it is positioned below the booklet placement board 250A (see FIG. 11(a)).

The motor M6 rotates a fan-shaped cam 247 via gears Z19 and Z20. The cam 247 rotates clockwise, as shown in the drawing, presses the trailing edge 249A of the reference alignment member 249, swings the leading edge of the reference alignment member 249 around the swinging shaft 248 in the direction indicated by the dot-dash line, as shown in the drawing, thereby making the reference alignment member 249 upright (see FIG. 11(b)). A sensor PS3 detects the initial position and the upright position of the reference alignment member 249.

Trimming Apparatus

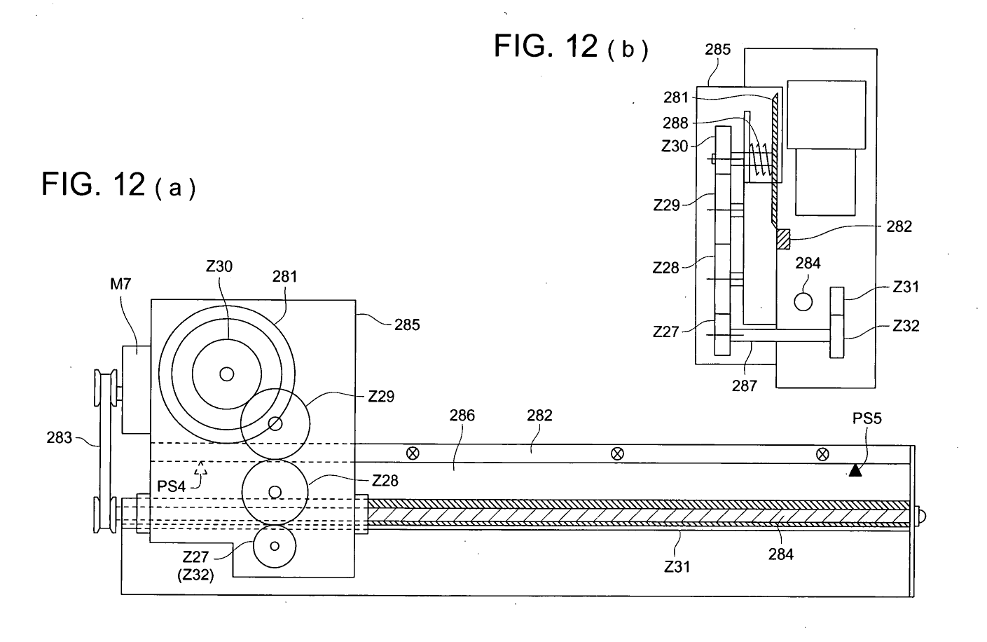

FIG. 12(a) is a front view of the trimming apparatus 280, and FIG. 12(b) is a side cross-sectional view of the trimming apparatus 280.

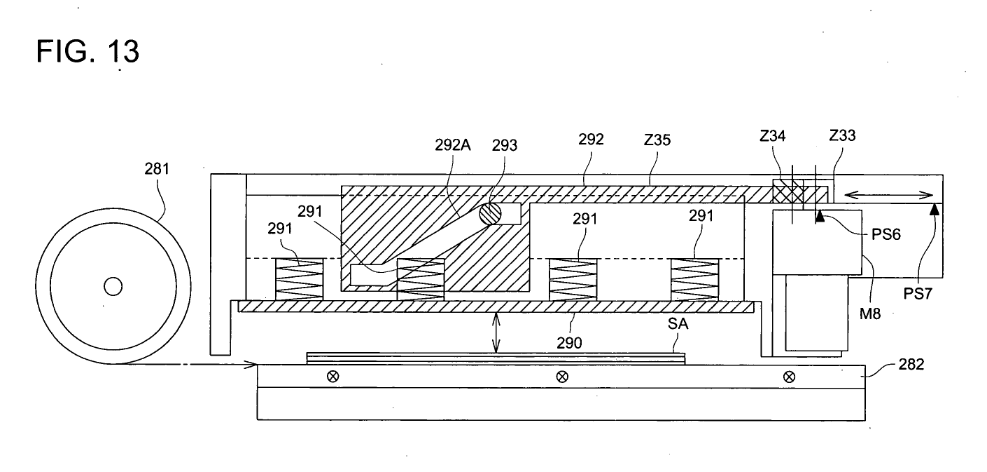

The trimming apparatus 280 comprises a rotating upper blade 281 which simultaneously rotates and moves straight in the width direction perpendicular to the direction of transporting a booklet, a fixed lower blade 282 mounted in the booklet's width direction, a drive mechanism for simultaneously rotating and moving straight the rotating upper blade 281, and a edge pressing member 290 (see FIG. 13) which presses the vicinity of the edge of the booklet SA.

The trimming apparatus 280 has a heavy weight and causes a large load at the time of trimming, therefore it is preferable that the trimming apparatus is arranged horizontally beneath the post-processing apparatus B. By arranging in such a way, cost increase due to a member for fixing the trimming apparatus 280 is suppressed, and steady good quality of trimming can be obtained.

The motor M7 rotates a ball screw 284 installed in the trimming apparatus' main body 286 via a timing belt 283, and moves straight the rotating upper blade's mobile body 285 on which a rotating upper blade 281 is installed. The rotating upper blade's mobile body 285 moves in a straight line between the initial position sensor (HP sensor) PS4 and a sensor PS5.

A rack gear Z31 is mounted to the trimming apparatus' main body 286 in parallel with the rotation center line of the ball screw 284. A pinion gear Z32 is located on the rotating upper blade's mobile body 285 in such a way that the gear can rotate, meshes with a rack gear Z31, and is then driven and rotates as the result of the movement of the rotating upper blade's mobile body 285. The rotation of the pinion gear Z32 rotates a gear Z27 mounted to the drive conveying shaft 287 which holds the pinion gear Z32, and rotates the rotating upper blade 281 via gears Z28, Z29 and Z30. Therefore, the motor M7 simultaneously rotates the rotating upper blade 281 and moves it in a straight line. The rotating upper blade 281 is pressed onto the fixed lower blade 282 by means of the force of the spring 288.

Drive Mechanism for Holding a Booklet

FIG. 13 is a cross-sectional view of a drive mechanism for a edge pressing member 290.

The edge pressing member 290 which presses the vicinity of the edge of the booklet SA is vertically driven by a cam mechanism and presses the booklet SA by means of a pressing spring 291. Although the thickness of booklets SA differs, the difference is reduced by means of a plurality of pressing springs 291.

The motor M8 rotates a pinion gear Z34 via a gear Z33, and then moves straight a transfer member 292 having a rack gear Z35 which meshes with the pinion gear Z34. A roller 293 installed in the edge pressing member 290 is movably engaged with a cam groove 292A located in the transfer member 292.

As the result of the straight movement of the transfer member 292, cam groove 292A presses down the roller 293, and then a transfer member 292 that clamps the roller 293 moves a prescribed distance and lowers to press the booklet SA.

Elevating of the edge pressing member 290 is restricted by the vertical length of the cam groove 292A located in the transfer member 292. Therefore, it is possible to control lifting and transfer of the edge pressing member 290 by means of sensors PS6 and PS7 detecting the distance the transfer member 292 moves in a straight line.

Drive Mechanism for Discharging Trimmed Scraps

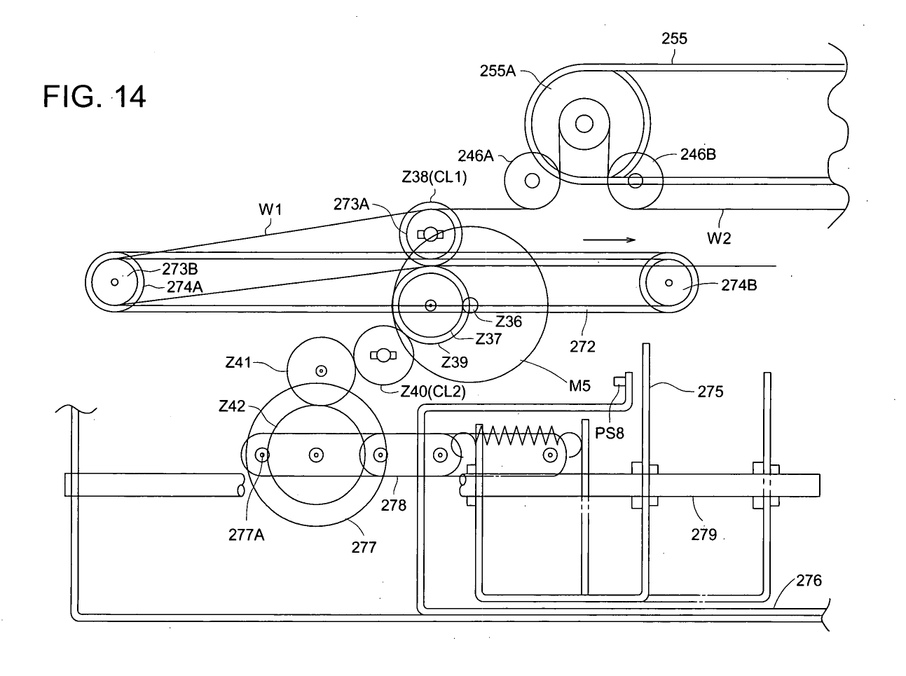

FIG. 14 is a cross-sectional view of a drive mechanism for discharging trimmed scraps.

The motor M5 rotates a discharge belt 255, rotates a trimmed-scrap transporting belt 272, and moves a transfer member 275 located in the trimmed-scrap container 276.

The motor M5 meshes with a gear Z38 incorporating a one-way clutch via gears Z36 and Z37. A wire W1 winds around a pulley 273A located on the same shaft as the gear Z38 and a pulley 273B. The trimmed-scrap transporting belt 272 winds around the pulley 274A located on the same shaft as the pulley 273B and the other pulley 274B.

As the motor M5 rotates in the forward direction, the trimmed-scrap transporting belt 272 is rotated in the direction indicated by the arrow via gears Z36 through Z38 and the wire W1. After the edge of a booklet has been trimmed by a trimming apparatus 280, trimmed scraps fall. Scraps are guided by an eject guide plate, not shown, fall on the rotating trimmed-scrap transporting belt 272, are transported and stored in the trimmed-scrap container 276.

The motor M5 rotates a rotating disc 277 via gears Z36 and Z37, a gear Z40 incorporating a one-way clutch, and gears Z41 and Z42. One end of a clank 278 engages with a shaft 277A installed at an eccentric position of the rotating disc 277. The other end of the clank 278 is connected to a transfer member 275. The transfer member 275 comes in sliding contact with the guide bar 279 so that it can moves back and forth.

Trimmed scraps which have been transported by a trimmed-scrap transporting belt 272 and ejected into the entrance of the trimmed-scrap container 276 are transported to the inner part of the trimmed-scrap container 276 by the transfer member 275 which moves back and forth.

A one-way clutch CL1 is built in the gear Z38 which meshes with a gear Z39 driven by the motor M5, and another one-way clutch CL2 is built in the gear Z40 which meshes with the gear Z39.

The drive mechanisms for the discharge belt 255 which discharges a trimmed booklet SA, trimmed-scrap transporting belt 272 and the transfer member 275 can be selectively controlled in such a way that the forward rotation of a single motor M5 drives the discharge belt 255, and the reverse rotation of the motor M5 drives the trimmed-scrap transporting belt 272 and the transfer member 275. As a consequence, it is possible to use the same drive source (motor M5) and selectively control the drive of the booklet SA discharge and the trimmed-scrap transportation.

Discharge Belt Drive Mechanism

A wire W2 winds around a pulley 273A, which is rotated by the motor M5, at a location different from where a wire W1 is wound. The wire W2 winds around pulleys 273A and 273C, a pair of pulleys 246A and 246B, and a pulley 245 mounted to the rotating shaft of the drive roller 255A of the discharge belt 255.

As the motor M5 drives, the wire W2 rotates, and rotation of the drive roller 255A will rotate the discharge belt 255.

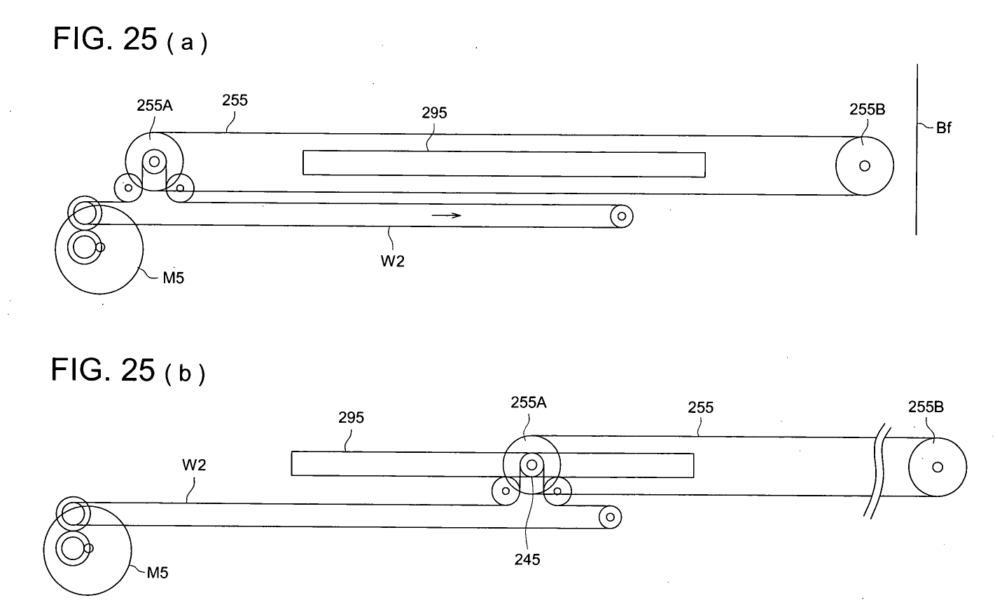

By electrically or manually pulling out the discharge belt 255 toward the front side Bf of the post-processing apparatus B, pulleys 245, 246A and 246B are also pulled out together with the drive roller 255A, and then moved to the location indicated by the broken line (see FIG. 7). Pulling out the discharge belt 255 will be explained in FIG. 25.

### The First Embodiment of Booklet Skew-Correcting Process and Trimming Process

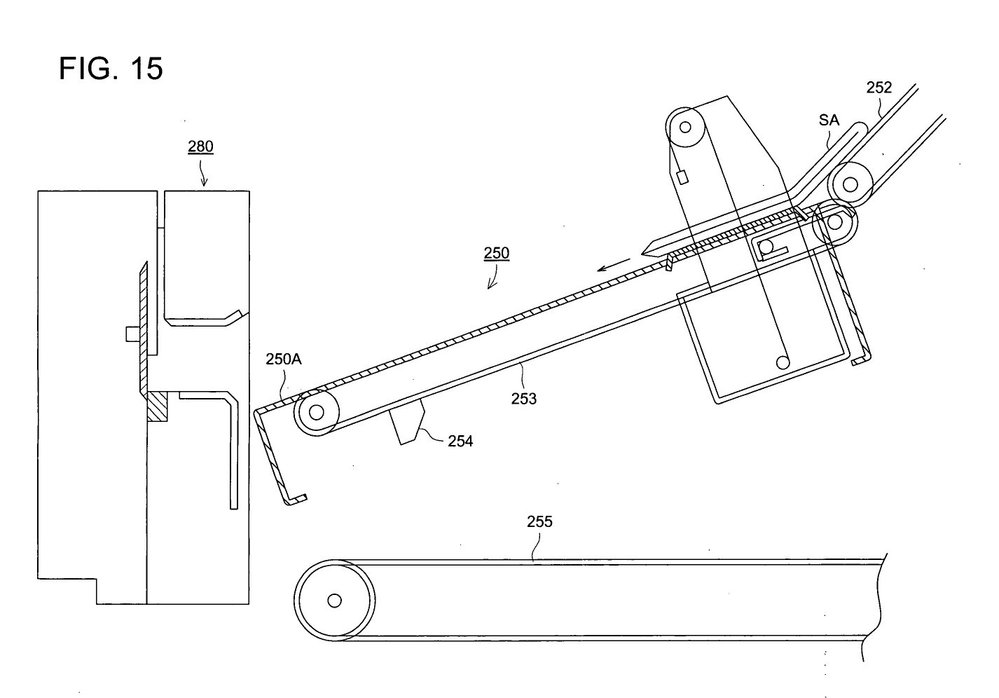

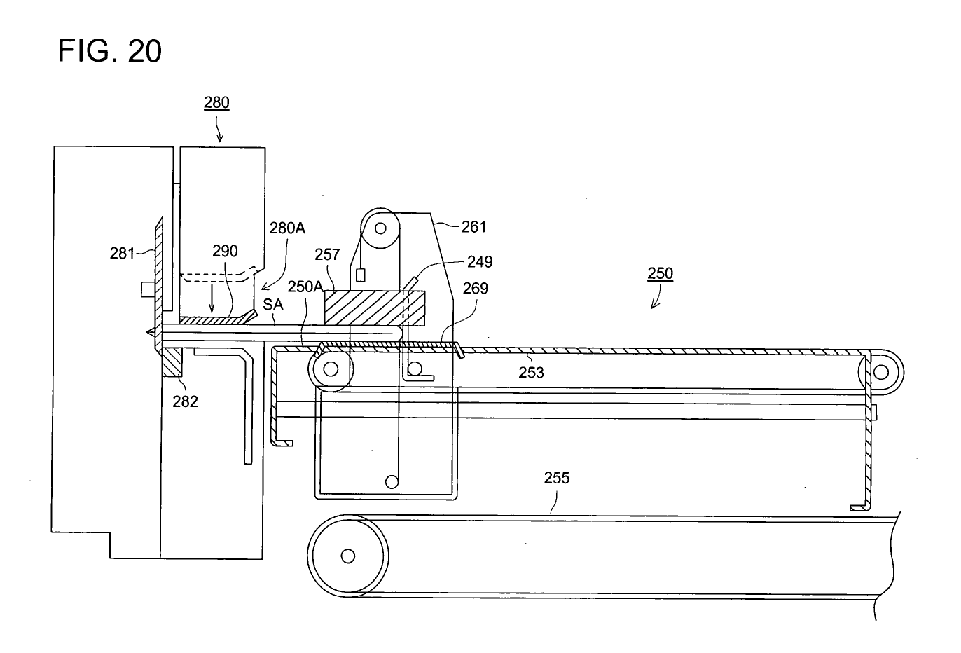

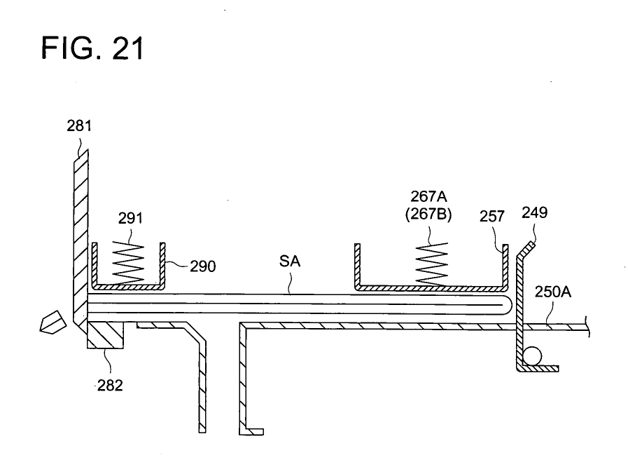

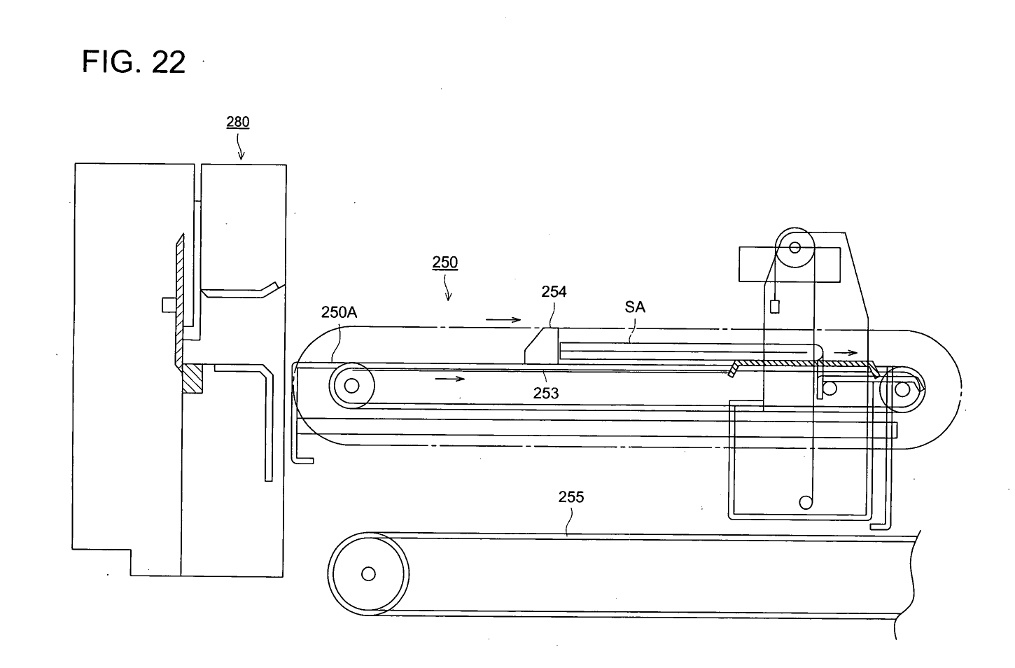

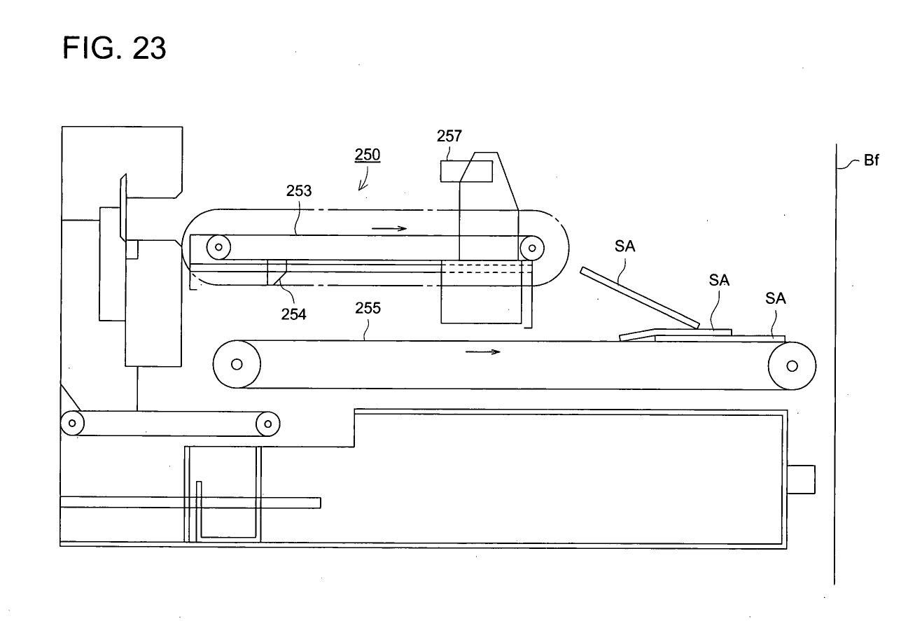

FIGS. 15 through 19 are cross-sectional views showing the process in which a center folded and saddle-stitched booklet SA is transported and carried into a trimming apparatus 280. FIGS. 20 and 21 are cross-sectional views showing the process in which a trimming apparatus 280 trims the edge portion of the booklet SA. FIGS. 22 and 23 are cross-sectional views showing the process in which the trimmed booklet SA is discharged.

(1) A booklet SA which slides down onto the inclined transporting belt 252 is transported, with its edge leading, on the booklet placement board 250A which is held at an inclined position (see FIG. 15).

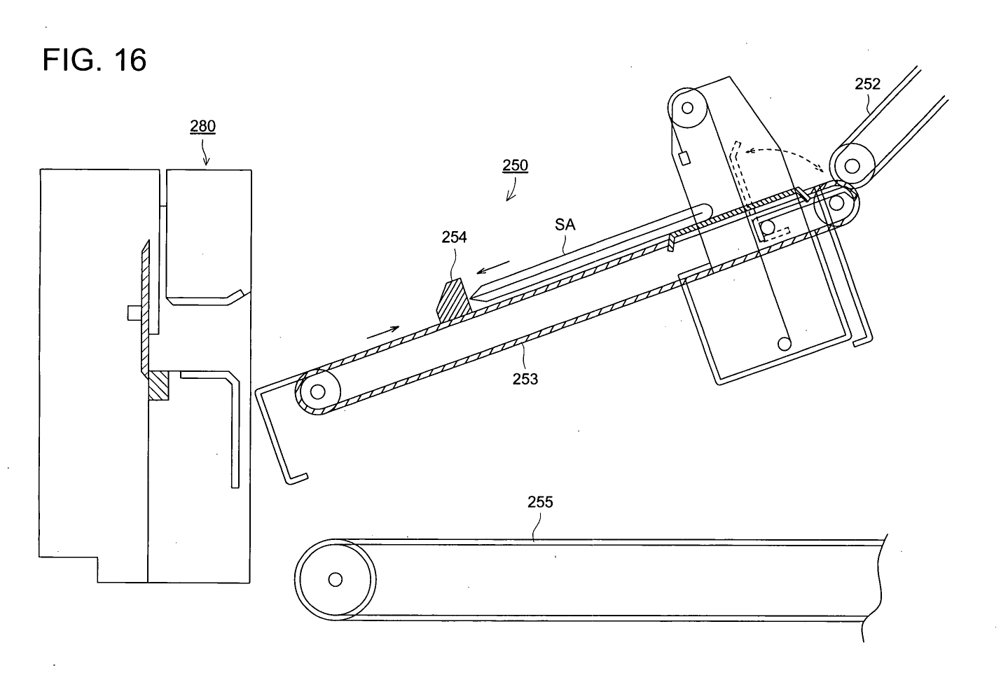

(2) The transporting belt 253 is rotated clockwise as shown in the drawing, and the contact member 254 advances to a prescribed position corresponding to the size of the sheet composing the booklet. The leading edge of the booklet SA which slides down onto the booklet placement board 250A contacts the contact member 254 and stops (see FIG. 16). Wherein, since the booklet placement board 250A is kept at the inclined position, the posture of the booklet with respect to the contact member 254 is easily adjusted by using the own weight of the booklet.

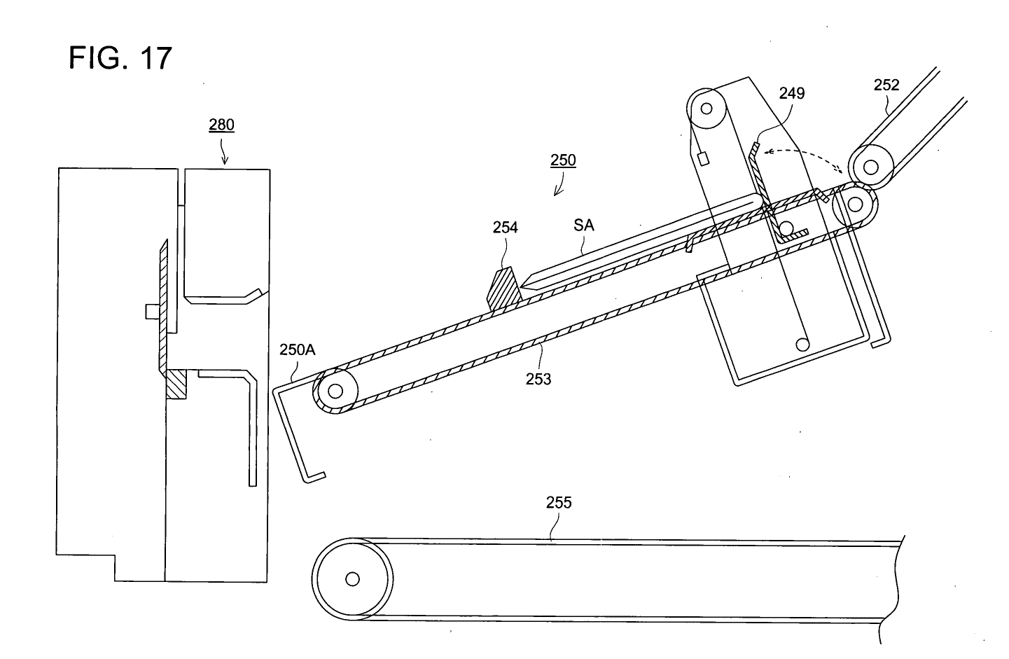

(3) The booklet misalignment correcting device (a skew-correcting device) comprises a reference alignment member 249 which can be raised and lowered, and a rotatable contact member 254. After the reference alignment member 249 has stood upright, the contact member 254 further advances in the direction indicated by the arrow, moves the leading edge of the booklet SA backward by pressing it, and then bumps the trailing edge of the booklet SA against the elevated reference alignment member 249, and finally misalignment of the booklet SA is corrected (see FIG. 17).

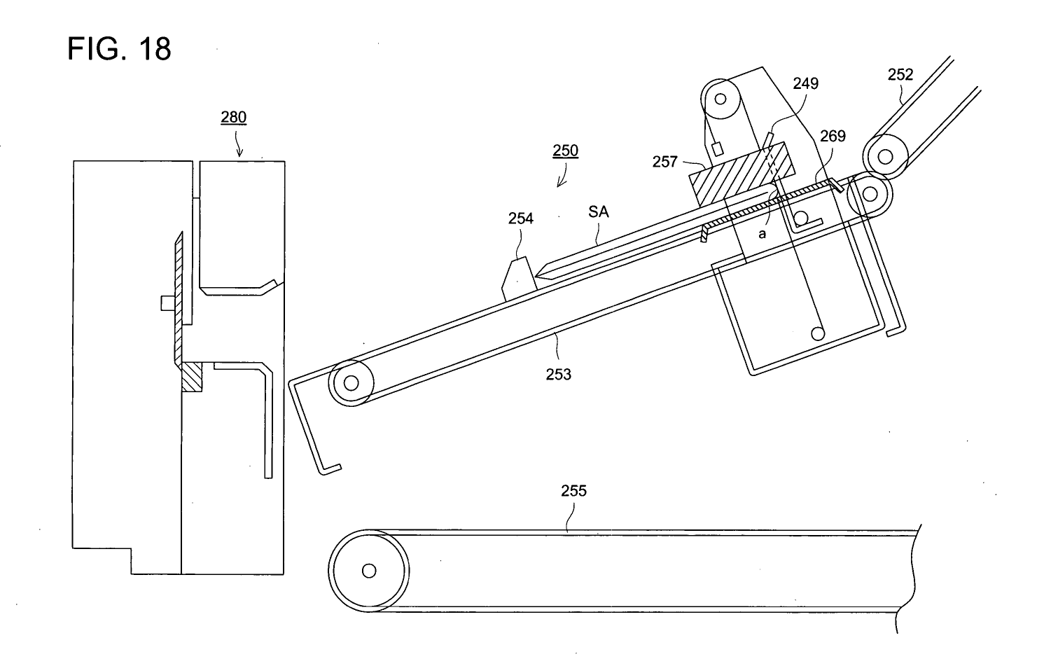

(4) A drive mechanism shown in FIGS. 8 and 10 lowers a pressing member 257, and the pressing member 257 presses and flattens the swollen portion in the vicinity of the fold “a” of the booklet SA which is loaded on the booklet supporting plate 269 (see FIG. 18). After the booklet SA has been pressed, the rotation of the transporting belt 253 is reversed and the contact member 254 is returned to the initial position.

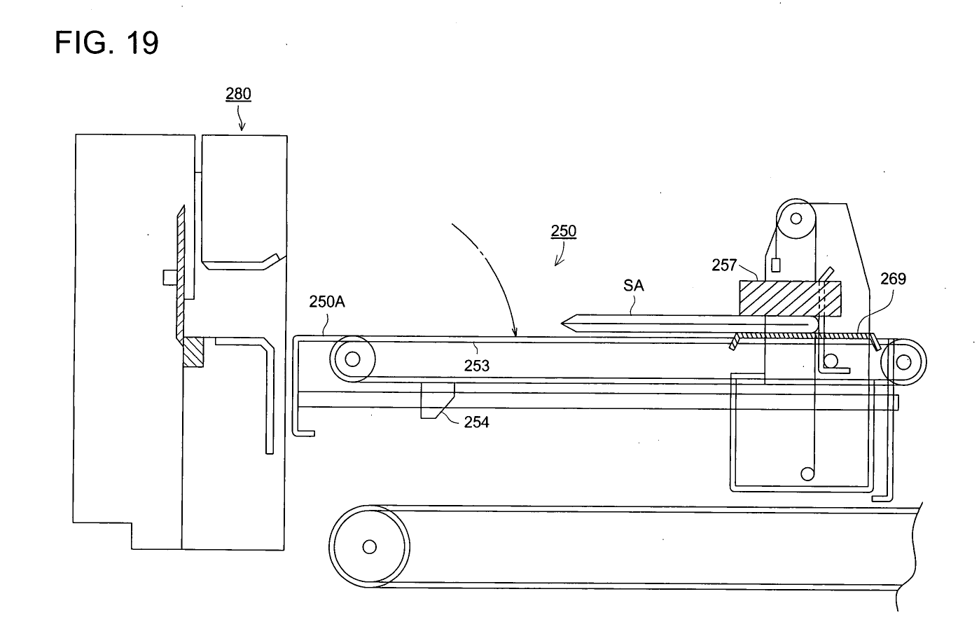

(5) The booklet transporting device 250 swings the booklet SA from the inclined position to a horizontal position while a pressing device comprising a pressing member 257 and a booklet supporting plate 269 presses and holds the vicinity of the booklet's fold “a” (see FIG. 19).

(6) While the pressing member 257 and the booklet supporting plate 269 press and hold the vicinity of the fold “a”, the pressing device (pressing unit) comprising the pressing member 257 and the booklet supporting plate 269 is moved to the left, as shown in the drawing, by means of a drive mechanism shown in FIG. 9, thereby inserting the edge of the booklet SA into the opening 280A (a trimming process opening section) of the trimming apparatus 280 (see FIG. 20).

(7) The booklet SA inserted at a trimming position in the trimming apparatus 280 is trimmed by a rotating upper blade 281 and a fixed lower blade 282 while being flattened by the pressing member 257 pressing the vicinity of the fold and the edge pressing member 290 pressing the vicinity of the edge (see FIG. 21).

(8) After the edge portion of the booklet has been trimmed, the pressing member 257 and the edge pressing member 290 stop pressing the booklet. Then, the transporting belt 253 rotates in the forward direction, the contact member 254 presses the edge of the booklet SA, and then the booklet is transported on the booklet placement board 250A to be discharged (see FIG. 22).

(9) When the edge of the booklet SA passes the swiveling position of the contact member 254 in the vicinity of the right end of the transporting belt 253 as shown in the drawing, the booklet is pushed by the contact member 254 and ejected downward from the booklet transporting device 250. The booklet SA is ejected to the rotating discharge belt 255 from above, and then is placed on top of the upper surface of the preceding booklet SA in a cascaded state.

When a small number of small booklets SA are stacked, the booklets can be unloaded by opening a door on the front side Bf of the post-processing apparatus B (see FIG. 23).

(10) Generally, the degree of swell of the center-folded and saddle-stitched booklet SA differs according to the type of paper and the number of sheets composing the booklet. A booklet SA which has a large number of sheets easily becomes bulky. When such a thick booklet SA is transported by a transporting belt 253 and loaded on the discharge belt 255 after it has been trimmed, it may not be placed in a neat cascaded state because the thick booklet SA comes in sliding contact with a swollen portion of a preceding booklet SA stacked on the discharge belt 255, causing friction resistance.

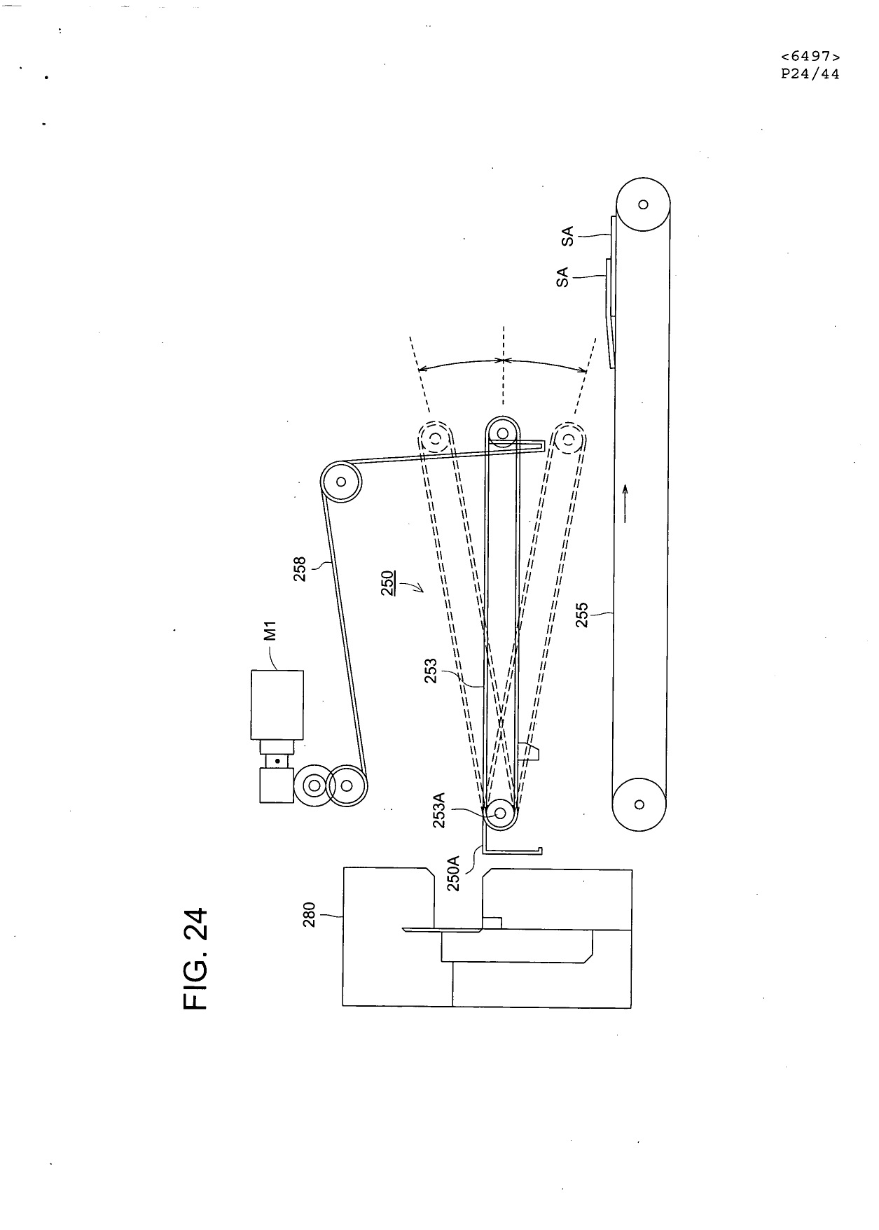

FIG. 24 is an explanatory drawing showing a variety of inclination angles of the booklet transporting device.

To change the angle, an elevating mechanism, shown in FIG. 8, is used to wind up a wire 258 and lift the discharge side of the transporting portion of the booklet transporting device 250, right side in the drawing, around the drive roller rotating shaft 253A.

The booklet SA transported on the booklet transporting device 250 is ejected slightly above the horizontal position, as shown in FIG. 23, and placed on the discharge belt 255. Therefore, a subsequently ejected booklet SA is stacked from above on top of the preceding booklet SA in a neat cascaded state which is made possible because there is less friction resistance between the booklets.

When a booklet SA contains a small number of sheets, the discharge side of the booklet transporting means 250, right side in the drawing, is lowered around the drive roller rotating shaft 253A.

The lifting and lowering of the booklet transporting device 250 is controlled by the operating portion 9 according to type of paper, the number of sheets and the size of sheets composing the booklet. Further it is also preferable to lift the booklet transporting device 250 according to progress in number of the booklets. By this, collision is effectively prevented between the already ejected booklet and the booklet to be subsequently ejected, and hard rubbing between the booklets can also be prevented to ensure good alignment of the ejected booklets.

(11) FIG. 25(a) is a cross-sectional view showing the state in which the discharge belt 255 is stored in the post-processing apparatus B. FIG. 25(b) is a cross-sectional view showing the state in which the discharge belt 255 is pulled out toward the front side Bf of the post-processing apparatus B.

The discharge belt 255 can be pulled out toward the front side Bf of the post-processing apparatus B. That is, by grasping a portion of a frame body, not shown, which supports the discharge belt 255 and pulling it out, the frame body comes in sliding contact with a sliding rail 295 supported by the main body of the post-processing apparatus B and then moves away.

As the frame body moves, the drive roller 255A which winds around the discharge belt 255 moves together, and the pulley 245 mounted to the rotating shaft of the drive roller 255A also moves. Even though the drive roller 255A moves, the motor M5 rotates the wire W2 which winds around the pulley 245, thereby rotating the drive roller 255A.

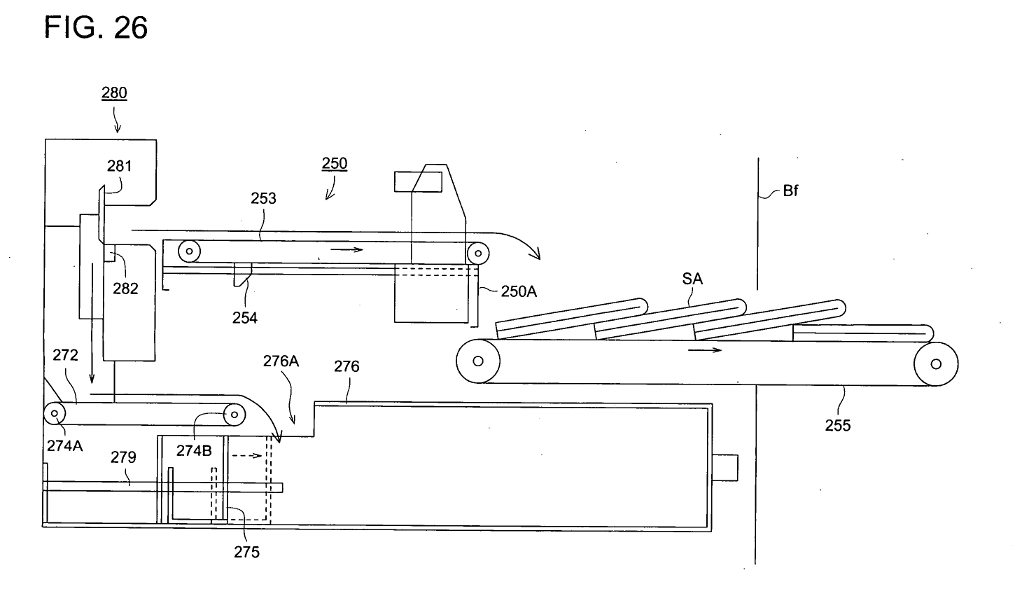

(12) FIG. 26 is a cross-sectional view showing the state in which booklets SA are stacked on the discharge belt 255. A booklet SA ejected from the transporting belt 253 located above is placed on the discharge belt 255 located below. The rotating discharge belt 255 one by one receives booklets SA ejected from the transporting belt 253, stacks them in a cascaded state, and transports them toward the front side Bf of the post-processing apparatus B. An operator can take out transported booklets SA one by one. Accordingly, it is possible to pull out the discharge belt 255 further than the front side Bf of the post-processing apparatus B and make it rotatable.

(13) As shown in FIG. 26, trimmed scraps which dropped from the edge of the booklet SA trimmed by both the rotating upper blade 281 and the fixed lower blade 282 of the trimming apparatus 280 are loaded on the rotating trimmed-scrap transporting belt 272 located below by means of a motor M5 and a drive mechanism shown in FIG. 14. The trimmed scraps are then transported to the right as shown in the drawing, discharged and drop in the vicinity of the pulley 274B, and then loaded into the opening 276A of the trimmed-scrap container 276 below.

The motor M5 and a drive mechanism, as shown in FIG. 14, move the transfer member 275 back and forth along the guide bar 279. Trimmed scraps which have accumulated in the vicinity of the opening 276A of the trimmed-scrap container 276 are transported to the right of the transfer member 275 as indicated by the broken line in the drawing, and then successively transported to the inner part of the trimmed-scrap container 276. When a sensor PS8 detects that the trimmed-scrap container 276 has been filled with scraps, it stops driving the post-processing apparatus B or activates an alarm. An operator replaces the trimmed-scrap container 276 with a new one, or discards trimmed scraps contained in the trimmed-scrap container 276 and continuously uses the same trimmed-scrap container 276.

### The Second Embodiment of Edge Trimming Apparatus

In the first embodiment of an edge trimming apparatus described previously, the saddle-stitched fold portion of a booklet is made to hit reference alignment member 249 for a correction of booklet transportation skew as shown in FIG. 17. In the second embodiment of an edge trimming apparatus, the edge of a booklet is made to hit a leading-edge stopper mounted near an edge trimming section for a correction of booklet transportation skew.

The mechanism of the trimming apparatus 90 and the drive mechanism for transporting booklets of the second embodiment will be explained in detail.

Drive Mechanism for Transporting Booklets

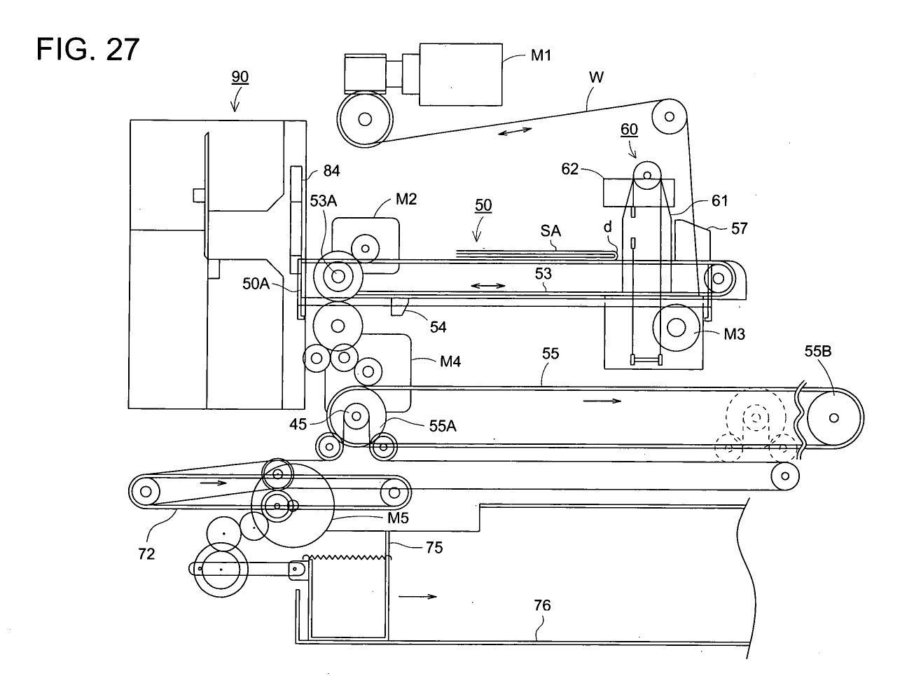

FIG. 27 is a schematic diagram of a drive mechanism for transporting booklet.

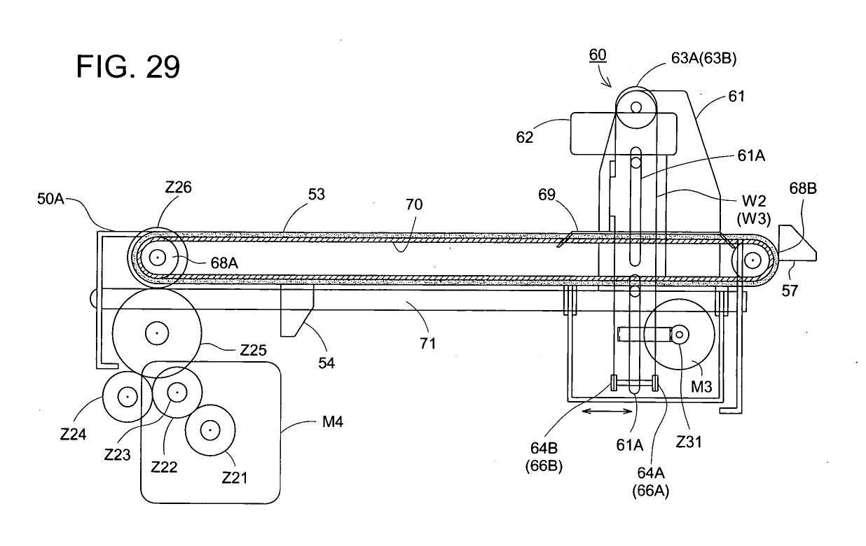

The motor M1 swings the transporting belt 53 around the drive roller rotating shaft 53A by means of wire W. The motor M2 rotates in two directions, forward and reverse, the transporting belt 53 which incorporates the movable alignment member 54. The motor M3 elevates the pressing member 62 which presses the vicinity of the fold “d” of the booklet SA. The motor M4 moves a mobile body 61 of booklet pinching transfer device 60 straight in the direction of transporting the booklet. (This will be explained in detail in FIG. 29.) The motor M5 rotates the discharge belt 55 which winds around both the drive roller 55A and the driven roller 55B, rotates the trimmed-scrap transporting belt 72, and moves the transfer member 75 of the trimmed-scrap container 76.

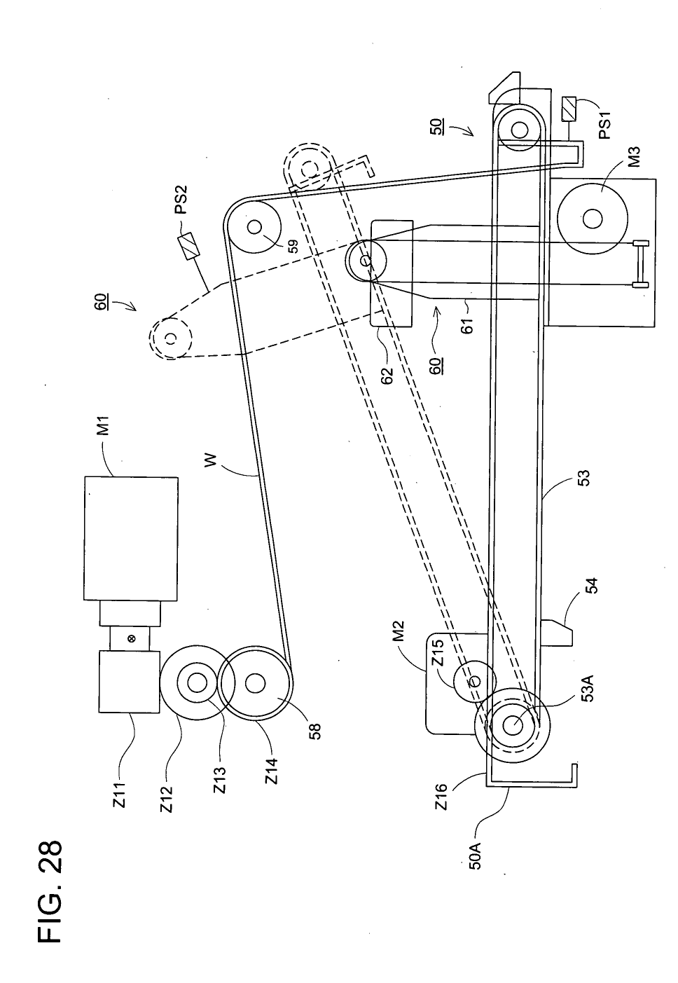

FIG. 28 is a cross-sectional view of a swinging mechanism for swinging a booklet transporting device 50.

The transporting belt 53 of the booklet transporting device 50 is supported such that it can swing around the drive roller rotating shaft 53A. A wire W one end of which is latched to the end (the right side as shown in the drawing) of the booklet transporting device 50 is deflected along the outer circumferential surface of the intermediate roller 59 which is rotatably supported by the apparatus' main body, and winds around the outer circumferential surface of the pulley 58, and then the other end of the wire is mounted to the pulley 58 in the tensioned state.

A gear Z14 mounted to the rotating shaft of the pulley 58 is connected to the gear Z11 which is mounted to the motor M1's drive shaft via the intermediate gears Z13 and Z12.

The motor M1 rotates the pulley 58 to wind up the wire W, lifts a booklet transporting device 50 comprising a booklet placement board 50A and a transporting belt 53, and swings the booklet transporting device 50 upward around the drive roller rotating shaft 53A and lifts it. The lifting position of the booklet transporting device 50 is indicated in the broken line. PS1 denotes a sensor for detecting the lower-limit position of the booklet transporting device 50 and PS2 denotes a sensor for detecting the upper-limit position of the booklet transporting device 50.

To lower the booklet transporting device 50 to a horizontal position, the motor M1 drives in the reverse direction to change the rotation direction of the pulley 58, releases the tension force of the wire W, and then the booklet transporting device 50 is allowed to be lowered by its own weight.

The motor M2 rotates the drive roller rotating shaft 53A via gears Z15 and Z16 to rotate the transporting belt 53 in the forward and reverse direction.

Drive Mechanism for Elevating the Pressing Member

FIG. 29 is a cross-sectional view which shows a booklet pinching transfer device 60 and a booklet aligning device.

The booklet pinching transfer device 60 comprises a mobile body 61, a booklet supporting plate 69 mounted to the mobile body 61, a pressing member 62 which can be elevated, a mobile-body drive mechanism, and a drive mechanism for elevating the pressing member.

The motor M3 elevates the pressing member 62 which presses the vicinity of the fold “d” of the booklet SA. The pressing member 62 is supported along the long groove 61A of the mobile body 61 such that it can be elevated.

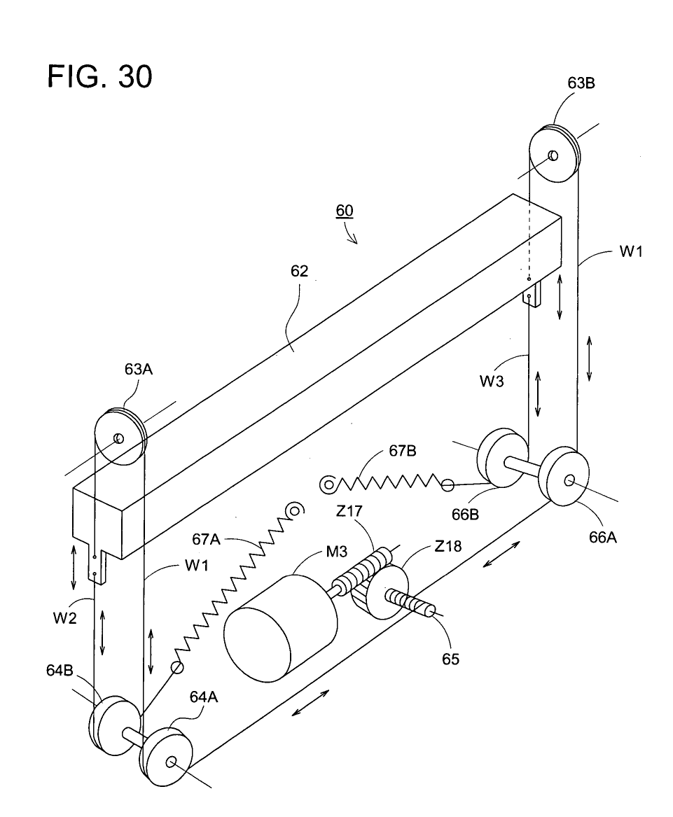

FIG. 30 is a perspective view of a drive mechanism for elevating a pressing member 62.

The 1st wire W1 one end of which is latched to the pressing member 62 winds around the sheave 63A, winds around the pulley 64A, also winds around the outer circumferential surface of the pulley 65 a plurality of times, and then winds around the pulley 66A, winds around the sheave 63B, and then the other end of the wire W1 is mounted to the pressing member 62 in the tensioned state.

The 2nd wire W2 one end of which is latched to the pressing member 62 winds around the pulley 64B and then connected to one end of the spring 67A. The other end of the spring 67A is latched to the apparatus' main body.

The 3rd wire W3 one end of which is latched to the pressing member 62 winds around the pulley 66B and then connected to one end of the spring 67B. The other end of the spring 67B is latched to the apparatus' main body.

The forward rotational drive of the motor M3 rotates the pulley 65 in the forward direction via gears Z17 and Z18, and the wire W1 is wound up and then the pressing member 62 is elevated via the sheaves 63A and 63B.

The reverse rotational drive of the motor M3 reverses the rotation of the pulley 65, and the wire W1 changes the position in the reverse direction, making it possible to lower the pressing member 62 via sheaves 63A and 63B. The wire W2 latched to the pressing member 62 lowers the pressing member 62 by means of the force of the spring 67A. Simultaneously, the wire W3 latched to the pressing member 62 lowers the pressing member 62 by means of the force of the spring 67B. As the pressing member 62 lowers, the vicinity of the fold “d” of the booklet SA loaded on the booklet placement board 50A is pressed.

Booklet Pinching Transfer Device

In FIG. 29, the motor M4 moves the pressing member 62 straight in the direction of transporting booklets. The rotational drive of the motor M4 rotates a drive pulley 68A via gears Z21, Z22, Z23, Z24, Z25 and Z26. A mobile body 61 is latched to the belt 70 which winds around the drive pulley 68A and the driven pulley 68B. The mobile body 61 is supported by the guide bar 71 which is installed on the booklet placement board 50A in parallel with the direction of transporting booklet so that the mobile body 61 can slide. The rotational drive of the motor M4 rotates the belt 70 and moves the mobile body 61 back and forth along the guide bar 71.

Elevating Drive Mechanism of Edge Pressing Member

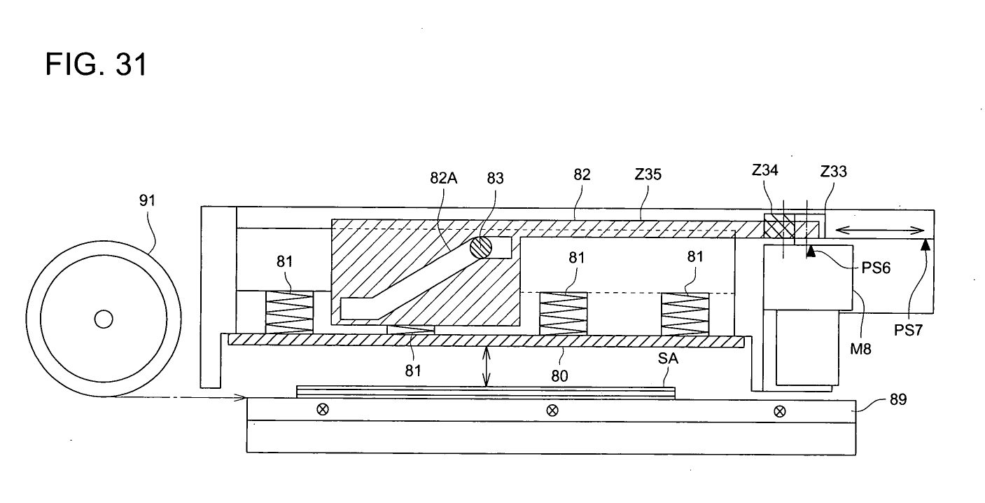

FIG. 31 is a cross-sectional view of a elevating drive mechanism for an edge-pressing member 80.

The edge-pressing member 80 which presses the vicinity of the edge of the booklet SA is vertically driven by a cam mechanism and presses the booklet SA by means of a pressing spring 81. Although the thickness of booklets SA differs, the difference is reduced by means of a plurality of pressing springs 81.

The motor M8 rotates a pinion gear Z34 via a gear Z33, and then moves straight a transfer member 82 having a rack gear Z35 which meshes with the pinion gear Z34. A roller 83 installed in the edge pressing member 80 is movably engaged with a cam groove 82A located in the transfer member 82.

As the result of the straight movement of the transfer member 82, cam groove 82A presses down the roller 83, and then a transfer member 82 that clamps the roller 83 moves a prescribed distance and lowers to press the booklet SA.

Elevating of the edge pressing member 80 is restricted by the vertical length of the cam groove 82A located in the transfer member 82. Therefore, it is possible to control elevating of the edge pressing member 80 by means of sensors PS6 and PS7 detecting the distance the transfer member 82 moves in a straight line.

Elevating Drive of Leading-Edge Stopper and Edge Pressing Member

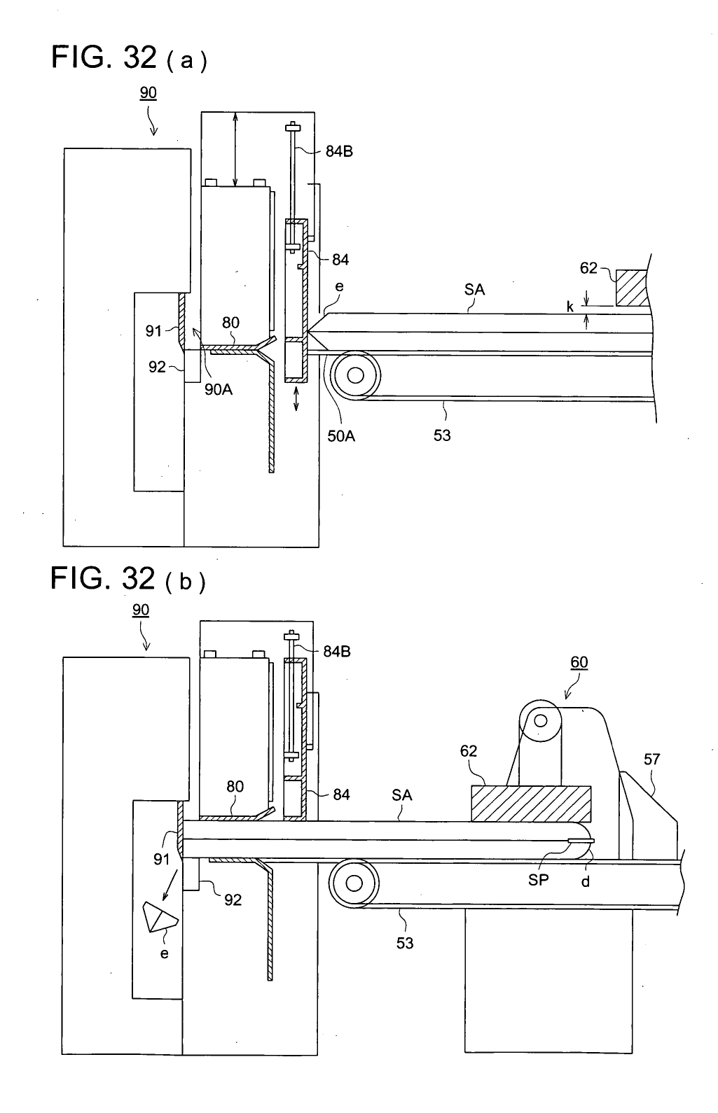

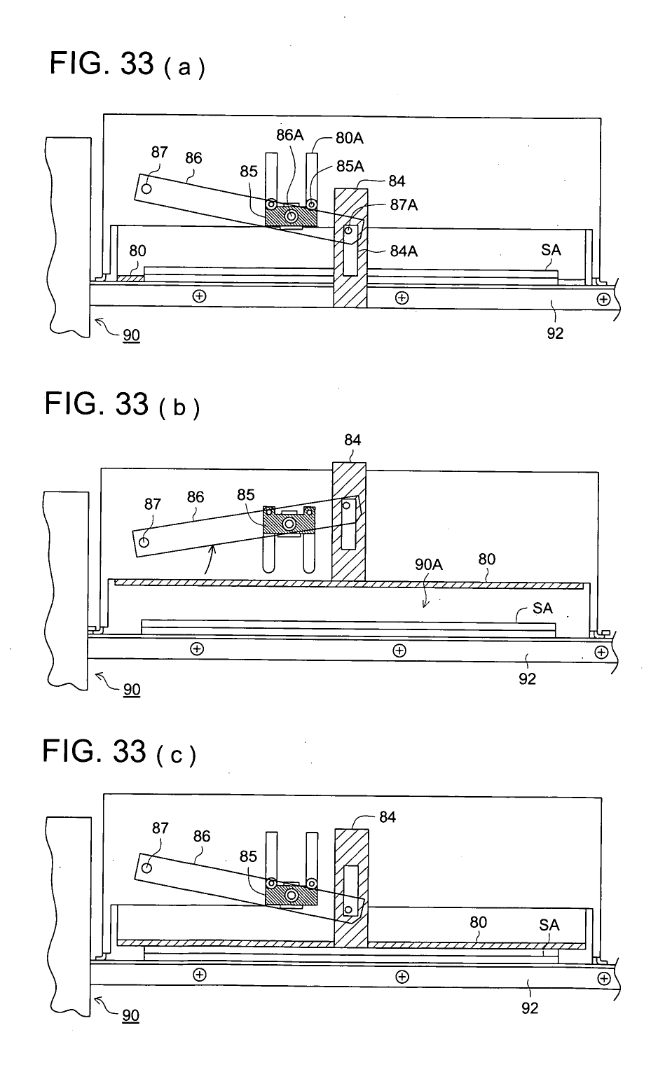

FIG. 32 shows a cross-sectional view around trimming apparatus 90 and FIG. 33 shows a side view around trimming apparatus 90.

FIG. 32(a) and FIG. 33(a) shows the condition when edge “e” of booklet is bumped against leading-edge stopper 84, FIG. 33(b) shows the condition when booklet SA is transported to trimming process opening section 90A and FIG. 32(b) and FIG. 33(c) show the condition when edge “e” of booklet SA is trimmed by trimming apparatus 90 with the vicinity of the edge pressed by a edge pressing member.

Movable member 85 is supported so that it can go up and down on edge of edge pressing member 80 which can be elevated by motor M8. Roller 85A retained on movable member 85 moves along groove 80A cut on edge pressing member 80 and makes the movable member 85 vertically movable. The movable member 85 is supported vertically movable by shaft 86A fixed to lever 86. The base portion of lever 86 is supported by pivot 87 to be allowed to swing. Shaft 87A fixed to the end of lever 86 moves along groove 84A on leading-edge stopper 84 and allows the leading-edge stopper 84 to ascend and descend. The lever 86 is vertically movable along guide bar 84B (see FIG. 32).

Motor M8 which is an independent driving source elevates edge pressing member 80 and elevates leading-edge stopper 84 via mobile member 85 and lever 86. The distance between pivot 87 and the end part of lever 86 is longer than the distance between the pivot 87 and shaft 86A on edge pressing member 80, and therefore, the elevating stroke of leading-edge stopper 84 is longer than that of edge pressing member 80.

Leading-edge stopper 84 is supported such that it can be lowered by own weight or spring urging force and it lowers in conjunction with lowering motion of edge pressing member 80 until it contacts the upper surface of the booklet SA and stops after the leading edge of booklet SA passes through there.

Trimming Apparatus

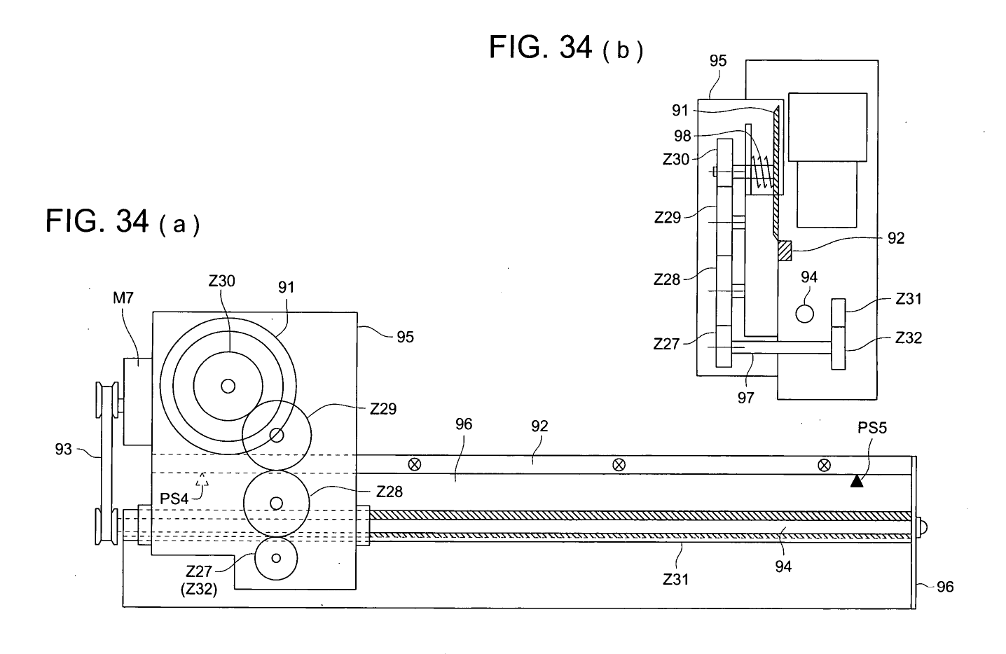

FIG. 34(a) is a front view of the trimming apparatus 90, and FIG. 34(b) is a side cross-sectional view of the trimming apparatus 90.

The trimming apparatus 90 comprises a rotating upper blade 91 which simultaneously rotates and moves straight in the width direction perpendicular to the direction of transporting booklet, a fixed lower blade 92 mounted in the booklet's width direction, a drive mechanism for simultaneously rotating and moving straight the rotating upper blade 91, and a edge pressing member 80 (see FIG. 33) which presses the vicinity of the edge of the booklet SA.

The motor M7 rotates a ball screw 94 installed in the trimming apparatus' main body 96 via a timing belt 93, and moves straight the rotating upper blade's mobile body 95 on which a rotating upper blade 91 is installed. The rotating upper blade's mobile body 95 moves in a straight line between the initial position sensor (HP sensor) PS4 and a sensor PS5.

A rack gear Z31 is mounted to the trimming apparatus' main body 96 in parallel with the rotation center line of the ball screw 94. A pinion gear Z32 is located on the rotating upper blade's mobile body 95 in such a way that the gear can rotates, meshes with a rack gear Z31, and is then driven and rotates as the result of the movement of the rotating upper blade's mobile body 95. The rotation of the pinion gear Z32 rotates a gear Z27 mounted to the drive transmitting shaft 97 which holds the pinion gear Z32, and rotates the rotating upper blade 91 via gears Z28, Z29 and Z30. Therefore, the motor M7 simultaneously rotates the rotating upper blade 91 and moves it in a straight line. The rotating upper blade 91 is pressed onto the fixed lower blade 92 by means of the force of the spring 98.

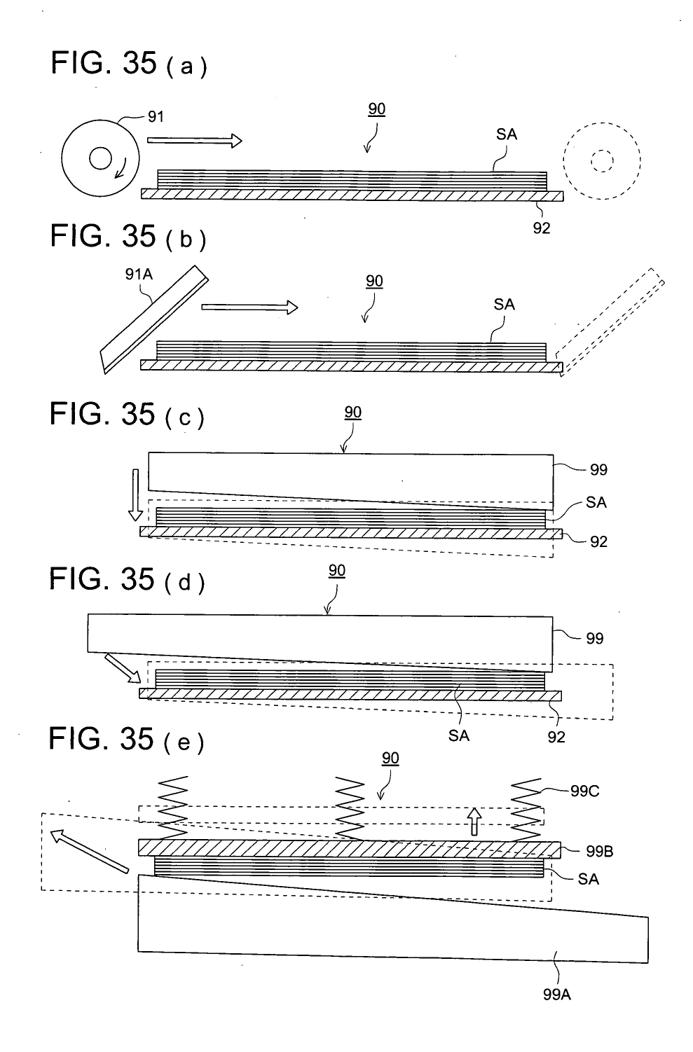

FIG. 35 is a cross-sectional view showing various kinds of examples of trimming apparatus 90. In these views, a trimming blade illustrated by solid lines indicates the starting position of trimming and a trimming blade indicated by broken lines is the finishing position of trimming.

FIG. 35(a) shows rotary cutter type trimming apparatus 90 having the rotating upper blade 91 and fixed lower blade 92. The rotating upper blade 91, rotating in the direction indicated by the black arrow and engaging fixed lower blade 92, moves straight in the direction indicated by the white arrow and trims edge portion “e” of booklet SA.

FIG. 35(b) shows a trimming apparatus 90 having a straight blade 91A instead of the rotating upper blade 91. The straight blade 91A moves in the direction indicated by the white arrow and trims edge portion “e” of booklet SA. With reference to straight blade 91A, NT cutter (registered trademark) on the market can be used.

FIG. 35(c) shows a trimming apparatus 90 having a fixed blade 92 and a movable upper blade 99. The movable upper blade 99 having an inclination angle lowers straight in the direction indicated by the white arrow, engaging fixed lower blade 92 and trims edge portion “e” of booklet SA from one end to another.

FIG. 35(d) shows another example of trimming apparatus 90 having a fixed blade 92 and a movable upper blade 99. The movable upper blade 99 having an inclination angle lowers obliquely in the direction indicated by the white arrow, engaging with fixed lower blade 92 and trims edge portion “e” of booklet SA from one end to another.

FIG. 35(e) shows another example of trimming apparatus 90. Movable lower blade 99A having an inclination angle rises obliquely in the direction indicated by the white arrow and trims edge portion “e” of booklet SA from one end to another. Receiving plate 99B like a chopping board holding the upper surface of booklet SA is supported by spring 99C and receives the edge of movable lower blade 99A.

### The Second Embodiment of Booklet Skew-Correcting Process and Trimming Process

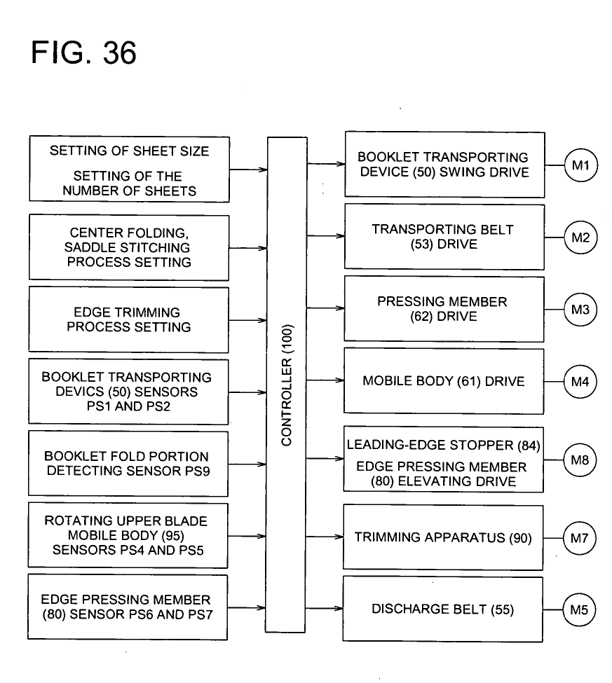

FIG. 36 is a block diagram showing how to control of sheet post-processing apparatus B.

In the operating portion of image forming apparatus A, the size of a sheet and the number of sheets are set and when a center folding, a saddle stitching process and an edge trimming process are set, controller 100 controls driving of transporting belt 53, discharge belt 55, booklet pinching transfer device 60, mobile body 61, pressing member 62., leading-edge stopper 84, edge pressing member 80 and trimming apparatus 90. Sensors PS1 through PS7 detect the positions of each member of sheet post-processing apparatus B and booklet SA and transmit the detection signal to controller 100.

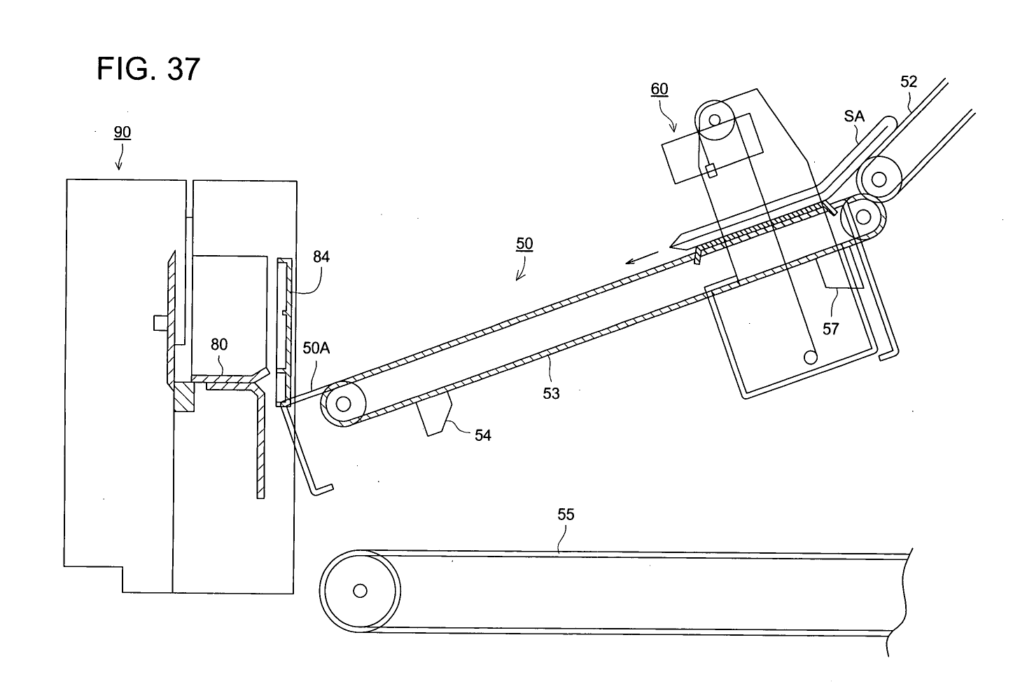

FIG. 37 through FIG. 41 are cross-sectional drawings showing the second embodiment of process in which booklet SA book-bound by center-folding and saddle-stitching is transported and fed to trimming apparatus 90 after a skew correction.

(1) A booklet SA which slides down onto the inclined transporting belt 52 is transported, with its edge “e” leading, on the booklet placement board 50A which is held at an inclined position (see FIG. 37).

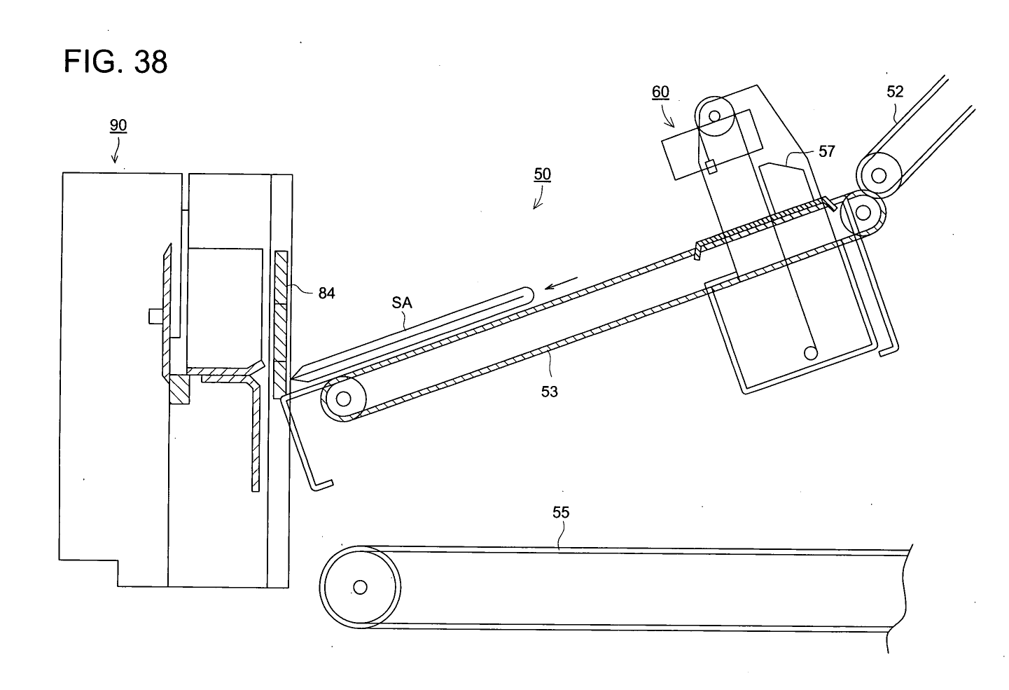

(2) The leading tip of edge of booklet SA sliding down on booklet placement board 50A is received by contacting leading-edge stopper 84 which is located near trimming process opening section 90A and has lowered (see FIG. 38).

(3) Booklet replacement board 50A and transporting belt 53 of booklet transporting device 50 are swung down to be held in the horizontal condition by a drive of motor M1 (see FIG. 28).

(4) By a drive of motor 4, mobile body 61 of booklet pinching transfer device 60 moves in the direction indicated by the arrow from the right side in the diagram and stops temporarily when sensor PS9 placed on booklet pinching transfer device 60 detects the trailing edge of fold “d” portion of booklet SA.

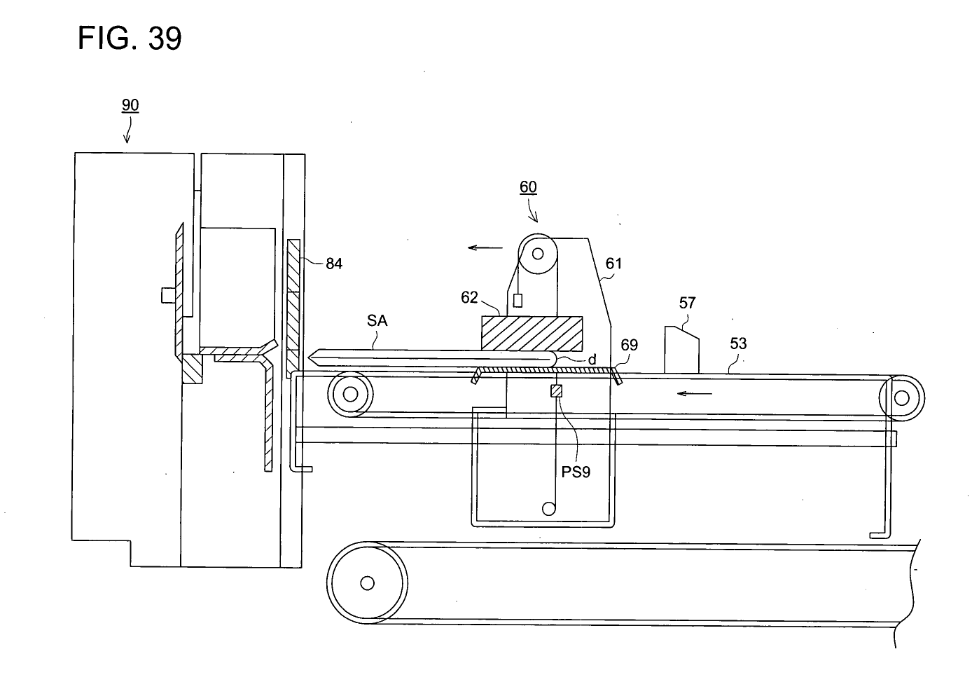

(5) Motor M3 lowers pressing member 62 of booklet pinching transfer device 60 and it presses the vicinity of the fold “d” of the booklet SA and flattens the swollen portion in the vicinity of the fold “d” (see FIG. 39).

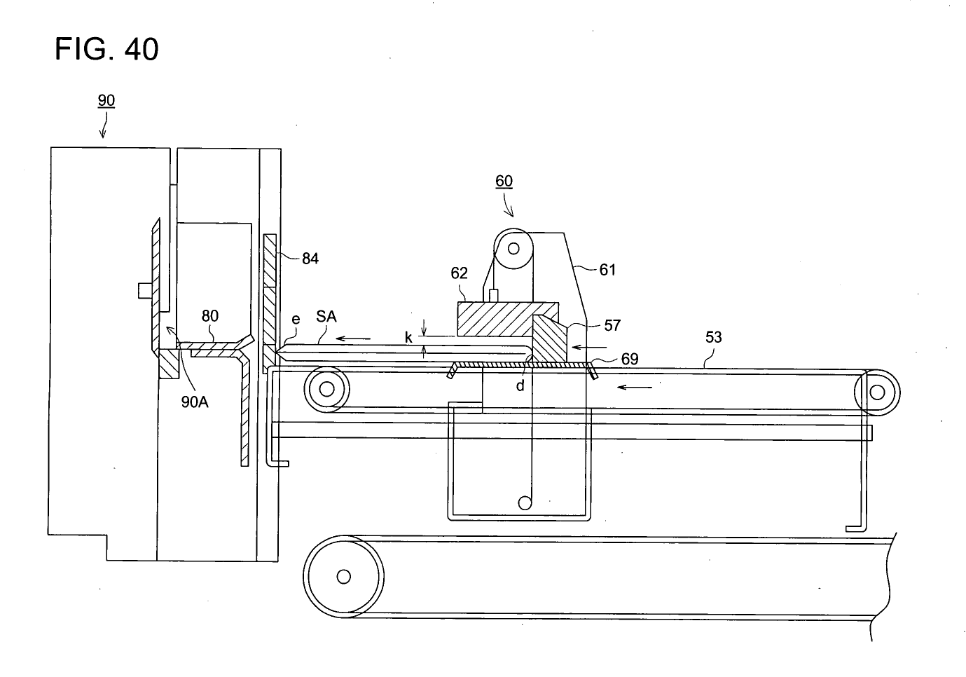

(6) The motor M3 lifts the pressing member 62 a prescribed distance to make some space “k” between the upper surface of booklet SA and the lower surface of the pressing member 62 (see FIG. 40).

(7) Motor M2 rotates transporting belt 53 in the direction indicated by the arrow and moves alignment member 57 fixed on transporting belt 53 to make it contact the fold “d” portion of booklet SA, and bumps the edge “e” of booklet SA against the leading-edge stopper 84 staying at the lower position to correct a skew of the booklet SA by motor M8 (see FIG. 32(a) and FIG. 40).

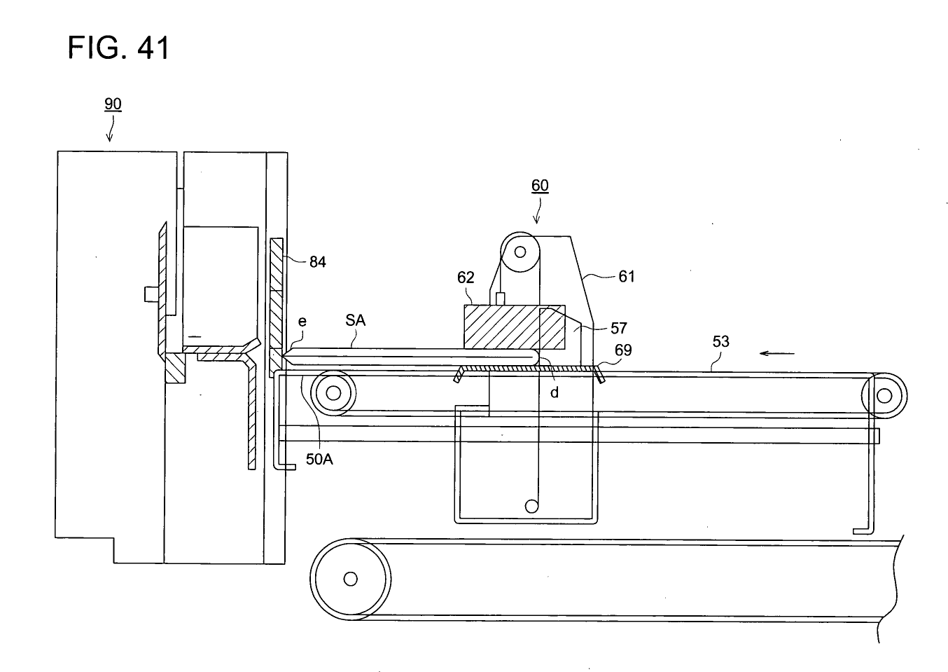

(8) After the correction of the skew of booklet SA, a drive of motor M3 lowers pressing member 62 again to press the vicinity of fold “d” of booklet SA to pinch the booklet SA on booklet supporting plate 69 (see FIG. 41).

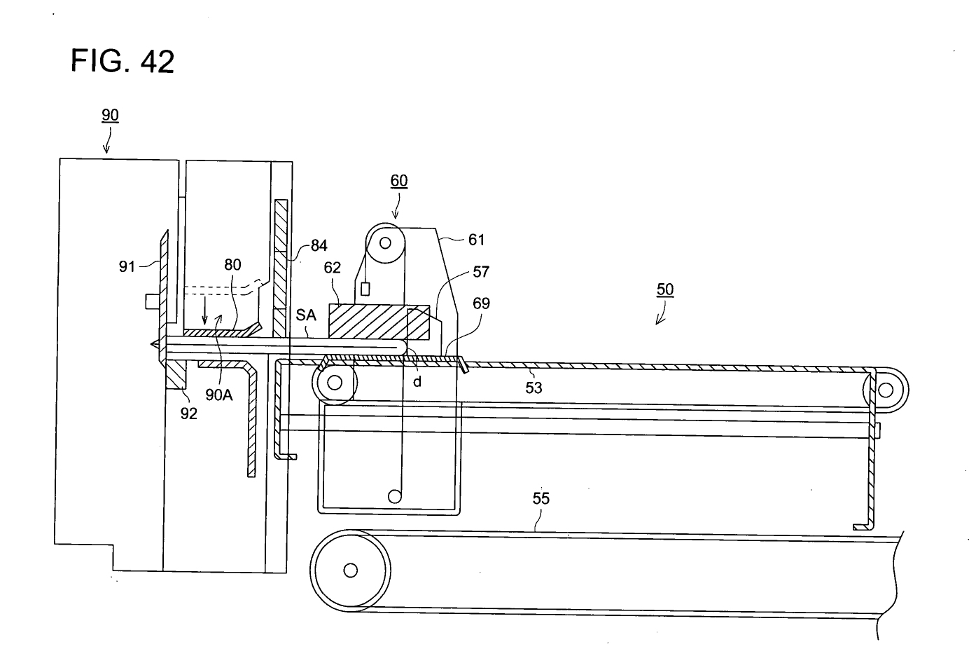

(9) A drive of motor M8 retreats the leading-edge stopper 84 and edge pressing member 80 upward to make trimming process opening section 90A clear (the position indicated by broken lines in FIG. 42).

(10) By moving booklet pinching transfer means 60 leftward in the diagram by a drive of motor M4, the vicinity of leading edge of booklet SA which travels being pinched by alignment member 57 and booklet supporting plate 69 passes through trimming process opening section 90A. The booklet pinching transfer device 60 is stopped at the prescribed position corresponding to the size of the sheet composing the booklet.

(11) A drive of motor M8 lowers leading-edge stopper 84 and edge pressing member 80 to press the vicinity of the edge of booklet SA and flatten it.

(12) Rotating upper blade 91 travels in the same direction as width of the booklet SA, keeping its rotation, by a drive of motor M7 and trims the edge of booklet SA in cooperation with fixed lower blade 92 (see FIG. 32(b) and FIG. 42).

### The Third Embodiment of Booklet Skew-Correcting Process and Trimming Process

Next, the third embodiment of the process in which booklet SA is transported to trimming apparatus 90 after a correction of its skew will be explained.

(1A) A booklet SA which slides down onto the inclined transporting belt 52 is transported, with its edge “e” leading, on the booklet placement board 50A which is held at an inclined position (see FIG. 37).

(2A) The leading tip of edge of booklet SA sliding down on booklet placement board 50A is received by contacting leading-edge stopper 84 which is located near trimming process opening section 90A and has lowered (see FIG. 38).

(3A) Booklet replacement board 50A of booklet transporting device 50 and transporting belt 53 are swung down to the horizontal condition by a drive of motor M1 (see FIG. 28).

(4A) By a drive of motor 4, transporting belt 53 is rotated in the direction indicated by the arrow in the diagram and alignment member 57 fixed on transporting belt 53 travels from the right side in the diagram and presses the fold “d” portion of booklet SA to touch the edge “e” of booklet SA to leading-edge stopper 84 and corrects a skew of booklet SA.

(5A) After the correction of the skew of booklet SA, a drive of motor M3 lowers pressing member 62 to press the vicinity of fold “d” of booklet SA on booklet supporting plate 69 to pinch the booklet SA.

(6A) A drive of motor M8 retracts the leading-edge stopper 84 and edge pressing member 80 upward to make trimming process opening section 90A clear.

(7A) Booklet pinching transfer device 60 pinching booklet SA is moved leftward in the diagram by a drive of motor M4 and allows the vicinity of leading edge of booklet SA to pass through trimming process opening section 90A. The booklet pinching transfer device 60 is stopped at the prescribed position corresponding to the size of the sheet.

(8A) A drive of motor M8 lowers leading-edge stopper 84 and edge pressing member 80 to press the vicinity of the edge of booklet SA and flatten it.

(9A) By a drive of motor M7, rotating upper blade 91 travels in the same direction as width of the booklet SA while it is rotating and trims the edge portion of the booklet SA in cooperation with fixed lower blade 92.

[Booklet Discharge Process]

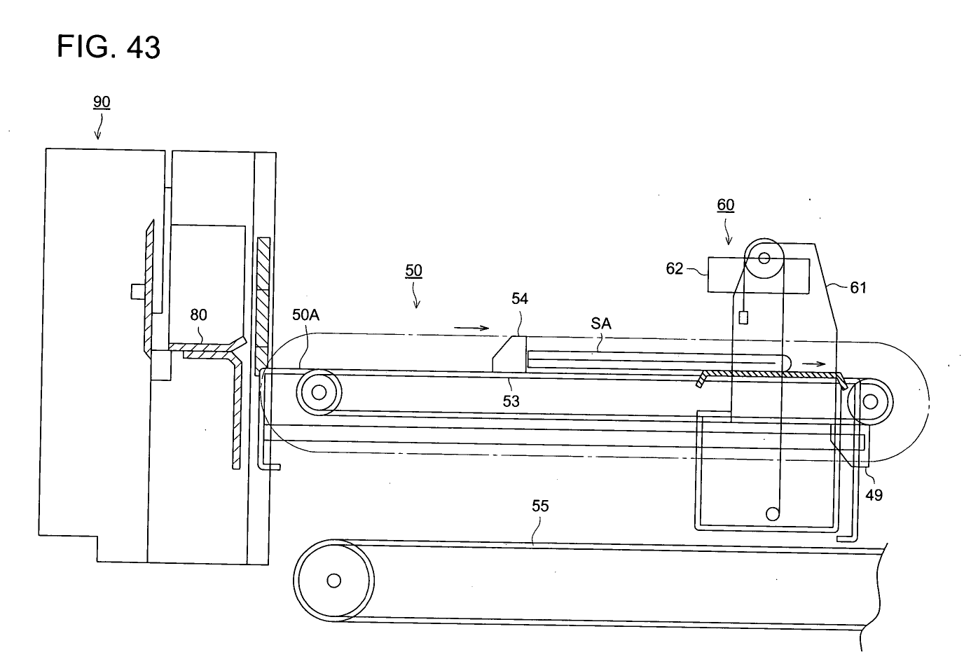

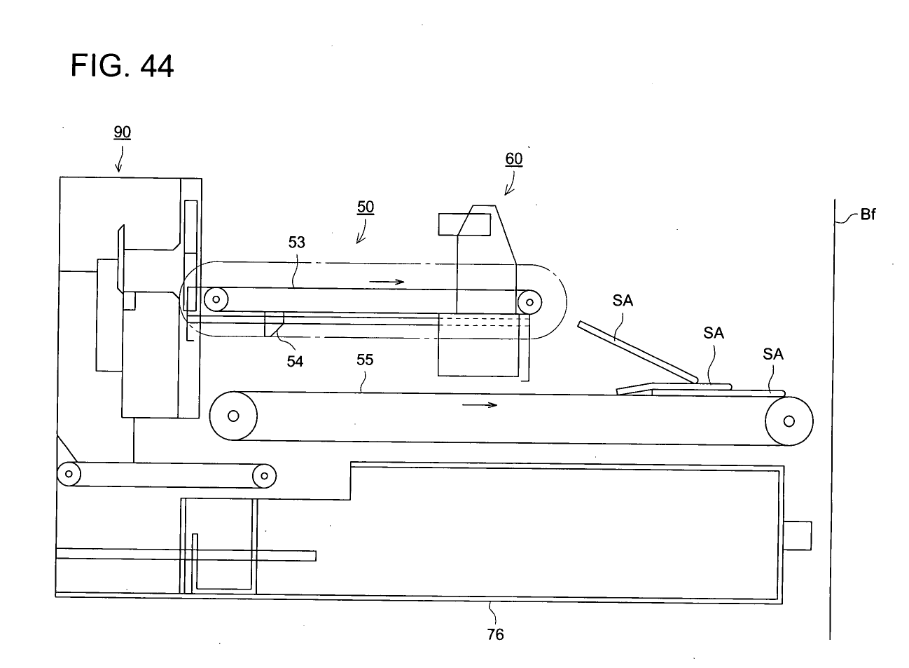

FIG. 43 and FIG. 44 are cross-sectional diagrams showing process of discharging trimmed booklet SA.

(1B) After the trimming process, a drive of motor M8 releases pressing of edge pressing member 80, and pressing member 62 is moved by a drive of motor M3 to the right side in the drawing, while it maintains pressing the vicinity of hold “d”.

(2B) When edge “e” of booklet SA moves near the upper portion of the rotation center of driving roller rotation shaft 53A rotating transporting belt 53, a drive of motor M3 releases pressing of pressing member 62, and subsequently, the transporting belt 53 starts rotation of the regular direction, when motor M2 is driven, and movable alignment member 54 fixed to transporting belt 53 presses edge “e” of booklet SA to transfer it on booklet placement board 50A in the direction of discharge (see FIG. 43).

When the edge “e” of the booklet SA passes the swiveling position of the movable alignment member 54 in the vicinity of the right end of the transporting belt 53 as shown in the drawing, the booklet is pushed by the movable alignment member 54 and ejected downward from the booklet placement board 50A. The booklet SA is ejected to the rotating discharge belt 55 from above, and then is placed on top of the upper surface of the preceding booklet SA in a cascaded state (see FIG. 44). The booklet SA can be unloaded by opening a door on the front side Bf of the sheet post-processing apparatus B.

In an embodiment according to the present invention, a sheet post-processing apparatus B which is connected to a image forming apparatus A and has center folding and saddle stitching functions has been explained. However, the present invention can apply to a sheet post-processing apparatus which first saddle-stitches a booklet and then center-folds it, and it is also possible to selectively connect a sheet post-processing apparatus having a paper folding device according to the present invention to a book binding device connected to a print-on-demand machine in order to consistently conduct multi-purpose, multi-functional post-processing.

Furthermore, the present invention can also apply to a sheet post-processing apparatus which is connected to an image-forming apparatus, such as a print-on-demand machine, printer, facsimile, multi-function printer, etc.

Moreover, it is also possible to configure a stand-alone sheet post-processing apparatus which is independent of an image-forming apparatus and thereby conducts a variety of folding processes.

According to the post-processing apparatus in the embodiment of the present invention, when the booklet is transported after the processing of the center-folding and the processing of saddle-stitching to the trimming device, since skew of the booklet is corrected, high quality of trimming can be achieved. Further since the booklet is inserted into the opening of the trimming device while it is pressed by the pressing member, it is adequately inserted to result in high quality of trimming. Furthermore, since the vicinity of the booklet edge is pressed for long period, bulge of the booklet is suppressed and the trimming is conducted while the booklet is in flattened condition, this results in high finishing quality of the booklet.

Furthermore, according to the post-processing apparatus in the embodiment of the present invention, the transporting plane angle of the booklet transporting device is variable, the transportation is highly stable at the time of receiving the booklet, inserting the booklet into the opening of the trimming device, and ejecting the booklet after the trimming. And, by making the transporting plane angle of the transporting device variable according to the kind, number and the size of the sheets composing the booklet, high stability can be achieved at the time of booklet ejection.

Furthermore, according to the image forming system in the embodiment of the present invention, after conducting a high-speed image forming, one-side recording, double-side recording, page collating and the like, the post-processing apparatus conducts a center folding processing and a saddle stitching processing, after that the trimming device can perform an exact and high-speed trimming processing. Therefore, the image forming system can achieve a high-speed and high productivity image forming.

In an embodiment according to the present invention, a post-processing apparatus which is connected to a copier's main body and has center folding and saddle stitching functions has been explained. However, the present invention can apply to a post-processing apparatus which first saddle-stitches a booklet and then center-folds it. It is also possible to selectively connect a post-processing apparatus having a paper folding device according to the present invention to a book binding device connected to a print-on-demand machine in order to consistently conduct multi-purpose, multi-functional post-processing.

Furthermore, the present invention can also apply to a post-processing apparatus which is connected to an image-forming apparatus, such as a print-on-demand machine, printer, facsimile, compound machine, etc.

Moreover, it is also possible to configure a stand-alone post-processing apparatus which is independent of an image-forming apparatus and thereby conducts a variety of folding processes.

1. A post-processing apparatus post-processing a booklet having a bundle of center-folded sheets and comprising:
a trimming apparatus trimming an edge portion of the booklet;
a skew-correcting device correcting a skew of the booklet;
a pressing device flattening the booklet by pressing; and
a transferring device conveying the booklet into a trimming process opening section of the trimming apparatus by transferring the pressing device;
wherein the booklet the skew of which is corrected by the skew-correcting device is pressed by the pressing device and the booklet is conveyed into the trimming process opening section by the transferring device while the booklet is pressed by the pressing device.

2. The post-processing apparatus of claim 1, which comprises a saddle-stitching device for saddle-stitching the booklet.

3. The post-processing apparatus of claim 1, which comprises an edge pressing member pressing the edge side of the booklet inserted into the trimming process opening section,
wherein the edge portion is trimmed by the trimming apparatus while the edge side is pressed by the edge pressing member.

4. The post-processing apparatus of claim 1, wherein said skew-correcting device comprising:
an inclinable reference alignment member; and
a contact member which transfers the booklet toward the reference alignment member by pressing an end of the booklet which opposes the end portion.

5. The post-processing apparatus of claim 1, wherein the skew-correcting device comprising:
a leading-edge stopper which can move up and down near the trimming process opening section; and
a movable alignment member bumping an edge of the booklet against the leading-edge stopper by pressing an edge of the booklet which opposes the edge.

6. The post-processing apparatus of claim 5 comprising:
an edge pressing device pressing the edge side of the booklet inserted into the trimming process opening section; and
a controller which controls so that after the edge of the booklet is bumped against the leading-edge stopper for a skew-correction by the skew-correcting device, the booklet is pressed by said pressing device, and after a retreat of the leading-edge stopper, the booklet is conveyed into the trimming process opening section by the transferring device while the booklet is pressed by the pressing device, and then, after the edge side is pressed by the edge pressing device, the edge portion of the booklet is trimmed by the trimming apparatus.

7. An image-forming system including post-processing apparatus which post-processes a booklet having a bundle of center-folded sheets comprising:
an image-forming apparatus recording images on sheets constituting the booklet;
a trimming apparatus trimming the edge portion of the booklet;
a skew-correcting device correcting a skew of the booklet;
a pressing device flattening the booklet by pressing; and
a transferring device conveying the booklet into a trimming process opening section of the trimming apparatus by transferring the pressing device;
wherein the booklet the skew of which is corrected by the skew-correcting device is pressed by the pressing device and the booklet is conveyed into the trimming process opening section by the transferring device while the booklet is pressed by the pressing device.
